(19) United States
(12) Patent Application Publication
(10) Pub. No.: US 2026/0339230 A1
(43) Pub. Date: Oct. 29, 2026

(54) IMAGE FORMING APPARATUS

(71) Applicant: CANON KABUSHIKI KAISHA, Tokyo (JP)

(72) Inventors: OSAMU SASAOKA, Kanagawa (JP); TOMOYA TATEISHI, Kanagawa (JP); SHUMA HIASA, Kanagawa (JP)

(21) Appl. No.: 19/730,140

(22) Filed: Jul. 2, 2026

Related U.S. Application Data
(63) Continuation of application No. PCT/JP2024/045217, filed on Dec. 20, 2024.

(30) Foreign Application Priority Data
Jan. 5, 2024 (JP) 2024-000582
Apr. 25, 2024 (JP) 2024-071430

(51) Int. Cl. G03G 15/01

(52) U.S. Cl. CPC G03G 15/0173; G03G 2215/0177

(57) ABSTRACT

An image forming apparatus includes (i) a developing unit including a developing roller, (ii) a rotary supporting the developing unit, the rotary being rotatable around a rotation axis extending in an axial direction, and (iii) a toner cartridge detachably mounted on the rotary. The toner cartridge includes a storage chamber storing toner, a guide portion configured to guide the toner, and a discharge opening through which the toner is discharged from the storage chamber to the developing unit. The guide portion is configured to guide, toward the discharge opening in the axial direction, the toner moving under a weight of the toner in a direction intersecting the axial direction.

### CROSS-REFERENCE TO RELATED APPLICATIONS

This application is a Continuation of International Patent Application No. PCT/JP2024/045217, filed Dec. 20, 2024, which claims the benefit of Japanese Patent Application No. 2024-000582, filed Jan. 5, 2024 and No. 2024-071430, filed Apr. 25, 2024, all of which are hereby incorporated by reference herein in their entirety.

### BACKGROUND

### Field of the Technology

The present disclosure relates to an image forming apparatus that forms an image on a recording medium.

### Description of the Related Art

In an electrophotographic image forming apparatus, a rotary developing system is known to form a color image by rotating a rotary assembly including a plurality of developing rollers. Japanese Patent Laid-Open No. 2007-183305 and Japanese Patent Laid-Open No. 2008-096852 describe image forming apparatuses that include a rotary with a plurality of developing rollers and a plurality of toner cartridges (toner containers) detachably mounted on the rotary.

### SUMMARY

The present disclosure is directed to a new image forming apparatus that has advanced the existing technology.

An aspect of the present disclosure is as follows.

An image forming apparatus includes:
a developing unit including a developing roller;
a rotary supporting the developing unit, the rotary being rotatable around a rotation axis extending in an axial direction; and
a toner cartridge detachably mounted on the rotary, the toner cartridge including a toner frame, the toner frame including
   (i) a storage chamber storing toner,
   (ii) a guide portion configured to guide the toner, and
   (iii) a discharge opening through which the toner supplied from the storage chamber to the developing unit passes, wherein
the guide portion is configured to guide, toward the discharge opening in the axial direction, the toner moving under a weight of the toner in a direction intersecting the axial direction,
the guide portion includes an inner end and an outer end, and, when viewed in the axial direction of the rotary, the inner end is closer to the rotation axis than the outer end in a radial direction of the rotary,
a length of the toner frame in a longitudinal direction of the toner frame is greater than a length of the toner frame in a transverse direction of the toner frame, and the length of the toner frame in the transverse direction is greater than a length of the toner frame in a thickness direction of the toner frame, and
the toner frame has a surface having the discharge opening and a surface to which the guide portion is connected, the surface having the discharge opening extends so as to intersect the thickness direction, and the surface to which the guide portion is connected extends so as to intersect the thickness direction.

An aspect of the present disclosure is as follows.

An image forming apparatus includes:
a developing unit including a developing roller;
a rotary supporting the developing unit, the rotary being rotatable around a rotation axis extending in an axial direction; and
a toner cartridge detachably mounted on the rotary, the toner cartridge including a toner frame, the toner frame including
   (i) a storage chamber storing toner,
   (ii) a guide portion configured to guide the toner, and
   (iii) a discharge opening through which the toner supplied from the storage chamber to the developing unit passes, wherein
the guide portion is configured to guide, toward the discharge opening in the axial direction, the toner moved by rotation of the rotary,
the guide portion includes an inner end and an outer end, and, when viewed in the axial direction of the rotary, the inner end is closer to the rotation axis than the outer end in a radial direction of the rotary,
a length of the toner frame in a longitudinal direction of the toner frame is greater than a length of the toner frame in a transverse direction of the toner frame, and the length of the toner frame in the transverse direction is greater than a length of the toner frame in a thickness direction of the toner frame, and
the toner frame has a surface having the discharge opening and a surface to which the guide portion is connected, the surface having the discharge opening extends so as to intersect the thickness direction, and the surface to which the guide portion is connected extends so as to intersect the thickness direction.

Features of the present disclosure will become apparent from the following description of embodiments with reference to the attached drawings.

### BRIEF DESCRIPTION OF THE DRAWINGS

FIG. 1 is a schematic view of an image forming apparatus according to a first embodiment.

FIG. 2 is a block diagram of the image forming apparatus according to the first embodiment.

FIG. 3 is a schematic view of a developing unit, a toner cartridge, and a tray according to the first embodiment.

FIG. 4A is a cross-sectional view of the image forming apparatus according to the first embodiment.

FIG. 4B is a cross-sectional view of the image forming apparatus according to the first embodiment.

FIG. 5 is a perspective view of a rotary body according to the first embodiment.

FIG. 6A is a perspective view of the image forming apparatus according to the first embodiment.

FIG. 6B is a perspective view of the image forming apparatus according to the first embodiment.

FIG. 6C is a perspective view of the image forming apparatus according to the first embodiment.

FIG. 7A is a cross-sectional view of the image forming apparatus according to the first embodiment.

FIG. 7B is a cross-sectional view of the image forming apparatus according to the first embodiment.

FIG. 8 is a view that illustrates the rotary body according to the first embodiment.

FIG. 9 is a view that illustrates the rotary body according to the first embodiment.

FIG. 10 is a view that illustrates the rotary body according to the first embodiment.

FIG. 11A is a view that illustrates a configuration related to the movement of the tray according to the first embodiment.

FIG. 11B is a view that illustrates the configuration related to the movement of the tray according to the first embodiment.

FIG. 12A is a view that illustrates the configuration related to the movement of the tray according to the first embodiment.

FIG. 12B is a view that illustrates the configuration related to the movement of the tray according to the first embodiment.

FIG. 13 is a view that shows the internal structure of the toner cartridge according to the first embodiment.

FIG. 14 is a cross-sectional view that shows the internal structure of the toner cartridge according to the first embodiment.

FIG. 15A is a schematic view of the toner cartridge revolving around a rotation axis when viewed in a Y direction according to the first embodiment.

FIG. 15B is a schematic view of the toner cartridge revolving around the rotation axis when viewed in the Y direction according to the first embodiment.

FIG. 16 is a schematic view of a rotary assembly rotating around the rotation axis when viewed in the Y direction according to the first embodiment.

FIG. 17 is a schematic view of the rotary assembly rotating around the rotation axis when viewed in the Y direction according to the first embodiment.

FIG. 18 is a view that shows the internal structure of a toner cartridge according to a second embodiment.

FIG. 19 is a view that shows the internal structure of a toner cartridge according to a third embodiment.

FIG. 20 is a view that shows a toner cartridge according to a first modification.

FIG. 21 is a view that shows the toner cartridge according to the first modification.

FIG. 22 is a view that shows the toner cartridge according to the first modification.

FIG. 23 is a view that shows a toner cartridge according to a second modification.

FIG. 24 is a view that shows the toner cartridge according to the second modification.

FIG. 25 is a view that shows the toner cartridge according to the second modification.

FIG. 26 is a view that shows a toner cartridge according to a third modification.

FIG. 27 is a view that shows the toner cartridge according to the third modification.

FIG. 28 is a view that shows the toner cartridge according to the third modification.

FIG. 29A is a perspective view that shows the internal structure of the toner cartridge according to the first embodiment.

FIG. 29B is a perspective view that shows the internal structure of the toner cartridge according to the first embodiment.

FIG. 30 is a view that shows the toner cartridge according to the first embodiment.

### DESCRIPTION OF THE EMBODIMENTS

Hereinafter, embodiments of the present disclosure will be described with reference to the attached drawings.

### First Embodiment

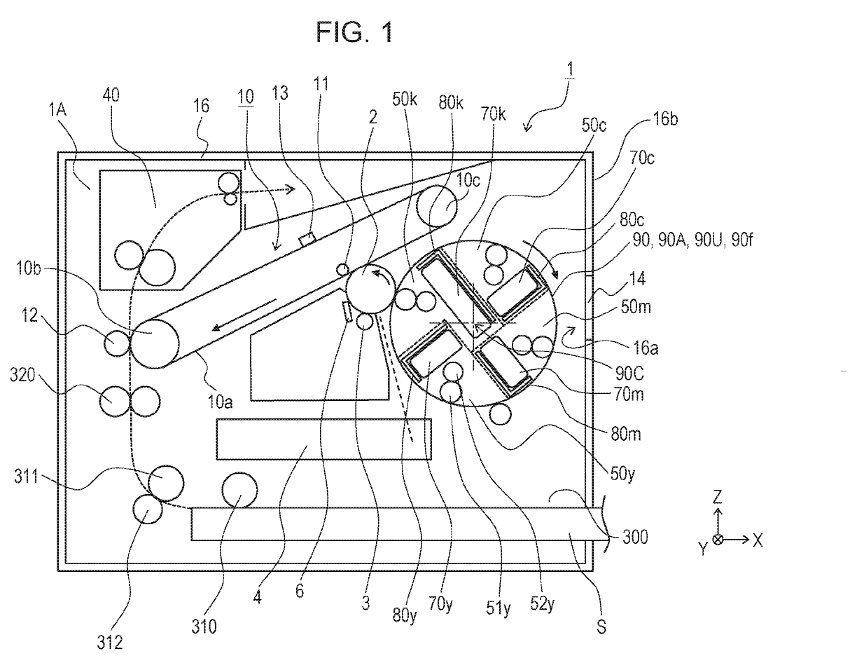

An image forming apparatus 1 according to a first embodiment will be described with reference to FIGS. 1 to 12A, and FIG. 12B.

In the following description and drawings, a vertical direction in a case where the image forming apparatus 1 is installed on a horizontal plane is defined as a Z direction. A direction that intersects the Z direction and that is a direction of a rotation axis 90C of a rotary body 90 (described later) (a rotation axis direction of a rotary) is defined as a Y direction. A direction that intersects both the Z direction and the Y direction is defined as an X direction. The X direction and the Y direction are preferably in a horizontal direction. The X direction, the Y direction, and the Z direction are preferably orthogonal to each other. As needed, the directions of the arrows X, Y, and Z shown in the drawings are referred to as +X side, +Y side, and +Z side, and their opposite sides are referred to as -X side, -Y side, and -Z side.

### Overall Configuration of Image Forming Apparatus

Initially, the overall configuration of the image forming apparatus 1 will be described. The image forming apparatus 1 is a laser beam printer that forms an image on a sheet S by using an electrophotographic method. More specifically, the image forming apparatus 1 is a color laser beam printer including four developing units 50y, 50m, 50c, and 50k. Various sheet materials of different sizes and materials, including paper, such as plain paper and thick paper, plastic film, cloth, sheet materials with surface treatment like coated paper, and special-shaped sheet materials, such as envelopes and index paper, can be used as the sheet S that is a recording material (recording medium).

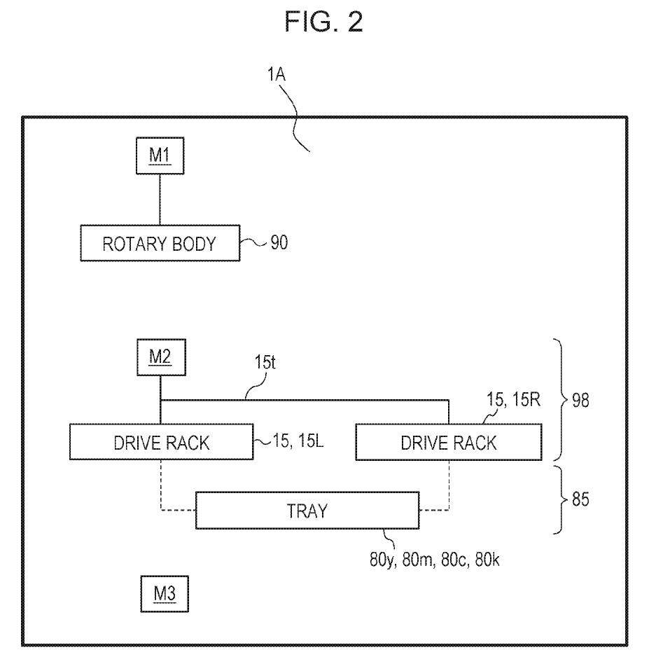

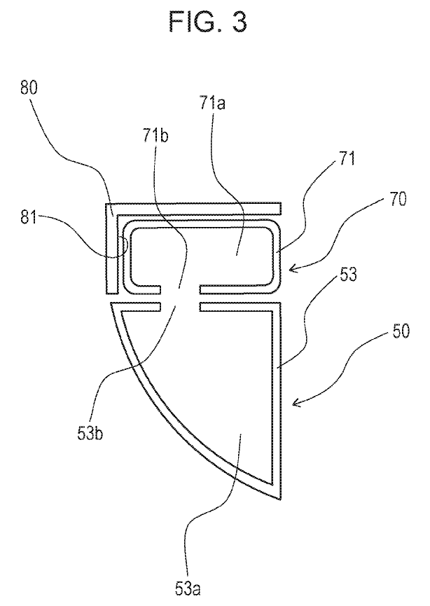

The schematic configuration and image forming operation of the image forming apparatus 1 will be described with reference to FIGS. 1, 2, and FIG. 3. FIG. 1 is a schematic view that shows the cross-sectional configuration of the image forming apparatus 1. FIG. 2 is a block diagram that illustrates a drive source of the image forming apparatus 1. FIG. 3 is a conceptual view that shows a configuration for supplying toner from a toner cartridge 70 to the developing unit 50.

As shown in FIG. 1, the image forming apparatus 1 includes an image forming apparatus main body (hereinafter, referred to as apparatus main body) 1A, and toner cartridges 70y, 70m, 70c, and 70k detachably mounted on the apparatus main body 1A. The apparatus main body 1A of the present embodiment is a portion excluding the toner cartridges 70y, 70m, 70c, and 70k from the image forming apparatus 1.

The apparatus main body 1A of the image forming apparatus 1 includes an electrophotographic photoconductor (hereinafter, photoconductor drum) 2 having a drum shape (cylindrical shape) as an image carrier that carries an electrostatic latent image. A charge roller 3, a scanner 4 serving as an exposure device, and a cleaning unit 6 are disposed around the photoconductor drum 2.

The charge roller 3 is an example of a charging device or charging unit for uniformly electrostatically charging the photoconductor drum 2. The scanner 4 is an example of an exposure device or exposure unit that performs exposure by irradiating the photoconductor drum 2 with a laser beam according to image information. By irradiating the electrostatically charged photoconductor drum 2 with a laser beam, an electrostatic latent image is formed on the surface of the photoconductor drum 2. The cleaning unit 6 is an example of a cleaning device or cleaning portion for removing toner remaining on the surface of the photoconductor drum 2.

The apparatus main body 1A includes a sheet storage chamber 300, a pick-up roller 310, a feed roller 311, a separation roller 312, a conveying roller pair 320, a secondary transfer roller 12, a fixing unit 40, and an intermediate transfer unit 10. The pick-up roller 310 is an example of a sheet feeder or sheet feeding unit that feeds the sheet S. The feed roller 311 and the separation roller 312 are an example of a separation conveying unit that conveys a sheet S while separating the sheet S one by one using frictional force. The secondary transfer roller 12 is an example of a transfer device or transfer unit that transfers an image from an intermediate transfer belt 10a to the sheet S.

The intermediate transfer unit 10 includes the intermediate transfer belt 10a, a belt drive roller 10b, a tension roller 10c, a cleaning device 13, and a primary transfer roller 11. The intermediate transfer belt 10a is an example of an intermediate transfer member that carries an image transferred (primary transfer) from the photoconductor drum 2 and conveys the image for transferring (secondary transfer) the image onto the sheet S. The intermediate transfer belt 10a is stretched between the belt drive roller 10b and the tension roller 10c. The belt drive roller 10b is a drive member that conveys the intermediate transfer belt 10a by being rotationally driven by a drive source.

The apparatus main body 1A includes the rotary body (a rotary, a rotating member, and a developing device) 90 with the developing units 50y, 50m, 50c, and 50k. As will be described later, in the present embodiment, trays (support members) 80y, 80m, 80c, and 80k are attached to the rotary body 90. The toner cartridges 70y, 70m, 70c, and 70k are detachably mounted on the trays 80y, 80m, 80c, and 80k.

In the following description, a plurality of members and the like having similar functions can be distinguished from each other by assigning numerals. For example, one of the toner cartridges 70y, 70m, 70c, and 70k can be called a first toner cartridge, one of the remaining three can be called a second toner cartridge, one of the remaining two can be called a third toner cartridge, and the last one can be called a fourth toner cartridge. Similarly, one of the trays 80y, 80m, 80c, and 80k can be referred to as a first tray, one of the remaining three can be referred to as a second tray, one of the remaining two can be referred to as a third tray, and the last one can be referred to as a fourth tray. In other words, one of the trays 80y to 80k is an example of a first support member, another one of the trays 80y to 80k is an example of a second support member, yet another one of the trays 80y to 80k is an example of a third support member, and the last one of the trays 80y to 80k is an example of a fourth support member. These designations are used for the sake of convenience of description and may be interchanged as needed.

The developing units (the first to fourth developing units) 50y, 50m, 50c, and 50k are examples of a developing device or developing portion that develops an electrostatic latent image formed on the photoconductor drum 2 into a toner image using toner of the corresponding color. Each of the developing units 50y, 50m, 50c, and 50k develops an electrostatic latent image formed on the photoconductor drum 2 using yellow toner, magenta toner, cyan toner, or black toner. The developing units 50y, 50m, 50c, and 50k may be arranged in a different order from the order shown in FIG. 1.

The developing unit 50y includes a developing roller 51y, a supply roller 52y, and a developing blade. The developing roller 51y is a developer carrier that rotates while carrying toner as a developer and supplies the toner to the photoconductor drum 2. The supply roller 52y is a supply member that is disposed so as to be in contact with the developing roller 51y and that supplies toner to the developing roller 51y. The developing blade is a regulating member that regulates the thickness of a toner layer carried on the developing roller 51y. The other developing units 50m, 50c, and 50k also include similar developing rollers 51m, 51c, and 51k, supply rollers 52m, 52c, and 52k, and developing blades, respectively.

The toner cartridges 70y, 70m, 70c, and 70k corresponding to the developing units 50y, 50m, 50c, and 50k are mounted on the rotary body 90. Yellow toner, magenta toner, cyan toner, and black toner are respectively stored in the toner cartridges 70y, 70m, 70c, and 70k as toners to be supplied to the developing units 50y, 50m, 50c, and 50k. One of the four-color toners may be regarded as a first toner, one of the remaining three-color toners may be regarded as a second toner, one of the remaining two-color toners may be regarded as a third toner, and the last toner may be regarded as a fourth toner. For example, black toner may be regarded as an example of the first toner, and magenta toner may be regarded as an example of the second toner. These designations are used for the sake of convenience of description and may be interchanged as needed.

Here, the rotary body 90 includes a rotary frame 90f that supports the developing units 50y, 50m, 50c, and 50k. The developing units 50y, 50m, 50c, and 50k are supported by the rotary frame 90f, which is a rotatable rotation support member.

The trays 80y, 80m, 80c, and 80k are attached to the rotary body 90. A combination of the rotary body 90 and the trays 80y, 80m, 80c, and 80k can be referred to as a rotary unit 90U. In other words, the rotary unit 90U includes the rotary body 90 and the trays 80y, 80m, 80c, and 80k.

The toner cartridges 70y to 70k are detachably held by the trays 80y to 80k, respectively. As will be described later, the trays 80y to 80k are supported so as to be slidable to the outside of the rotary body 90. A combination of the rotary unit 90U and the toner cartridges 70y, 70m, 70c, and 70k can be referred to as a rotary assembly 90A. In other words, the rotary assembly 90A includes the rotary unit 90U and the toner cartridges 70y, 70m, 70c, and 70k.

As will be described later, the rotary body 90 is rotatable around the rotation axis (rotation center) 90C. The rotation axis 90C coincides with the rotation axes of the rotary frame 90f, the rotary unit 90U, and the rotary assembly 90A. The rotation axis 90C is substantially parallel to the rotation axis (rotation center) of the photoconductor drum 2.

When the rotary body 90 rotates around the rotation axis 90C, any one of the developing rollers 51y, 51m, 51c, and 51k can take a development posture to face the photoconductor drum 2. A posture in which the developing roller 51y faces the photoconductor drum 2 is referred to as a yellow development posture. A posture in which the developing roller 51m faces the photoconductor drum 2 is referred to as a magenta development posture. A posture in which the developing roller 51c faces the photoconductor drum 2 is referred to as a cyan development posture. A posture in which the developing roller 51k faces the photoconductor drum 2 is referred to as a black development posture. In other words, the rotary body 90 can rotate around the rotation axis 90C such that the positions of the developing rollers 51y, 51m, 51c, and 51k relative to the photoconductor drum 2 are changed. The black development posture is an example of a first development posture in which a first developing roller (developing roller 51k) faces the photoconductor drum 2. The other development postures are examples of a second development posture in which a second developing roller (any one of the developing rollers 51y to 51c) faces the photoconductor drum 2. The yellow, magenta, cyan, and black development postures can also be referred to as first to fourth development postures. These designations are used for the sake of convenience of description and may be interchanged as needed.

As shown in FIG. 2, the apparatus main body 1A includes motors M1, M2, and M3 as drive sources. As will be described later, the motor M1 supplies driving force for rotating the rotary body 90 around the rotation axis 90C. In other words, the motor M1 rotates the rotary assembly 90A and the rotary unit 90U around the rotation axis 90C.

The apparatus main body 1A includes a drive device 98 including the motor M2 and a transmission device. The transmission device includes drive racks 15L and 15R serving as drive gears (described later), and a transmitting unit 15t. The driving force of the motor M2 is transmitted to the drive racks 15L and 15R by the transmitting unit 15t. In other words, the motor M2 is configured to drive the drive racks 15L and 15R and moves the trays 80y, 80m, 80c, and 80k relative to the rotary body 90 through the drive racks 15L and 15R.

The motor M3 drives members other than the members driven by the motor M1 or the motor M2. For example, the motor M3 drives the photoconductor drum 2, the developing units 50y, 50m, 50c, and 50k, the pick-up roller 310, the feed roller 311, the conveying roller pair 320, the secondary transfer roller 12, the belt drive roller 10b, and the fixing unit 40.

The members driven by the motors M1, M2, and M3 can be changed as needed. The roles of any two or three of the motors M1, M2, and M3 may be consolidated into a single motor. On the other hand, another drive source other than the motors M1, M2, and M3 may be added.

The suffixes y, m, c, and k of the developing units 50y, 50m, 50c, and 50k, the toner cartridges 70y, 70m, 70c, and 70k, and the trays 80y, 80m, 80c, and 80k each indicate the color of toner. The basic configurations and functions of the developing units 50y, 50m, 50c, and 50k are common. The basic configurations and functions of the toner cartridges 70y, 70m, 70c, and 70k are common. The basic configurations and functions of the trays 80y, 80m, 80c, and 80k are common. Therefore, when the units, cartridges, or trays do not need to be distinguished from one another, the suffixes y, m, c, and k are omitted, and the units, cartridges, or trays will be described on the assumption that there is any one of the four units, cartridges, or trays.

As shown in FIG. 3, the toner cartridge 70 includes a toner frame 71. The toner frame 71 has a toner storage chamber 71a that stores toner, and a discharge opening 71b that communicates with the toner storage chamber 71a.

The developing unit 50 has a developing frame (storage frame) 53. The developing frame 53 includes a developing-side storage chamber 53a and a receiving opening 53b that communicates with the developing-side storage chamber (toner supply chamber) 53a. As described earlier, the developing unit 50 includes the developing roller 51, the supply roller 52, and the like; however, these components are omitted in FIG. 3.

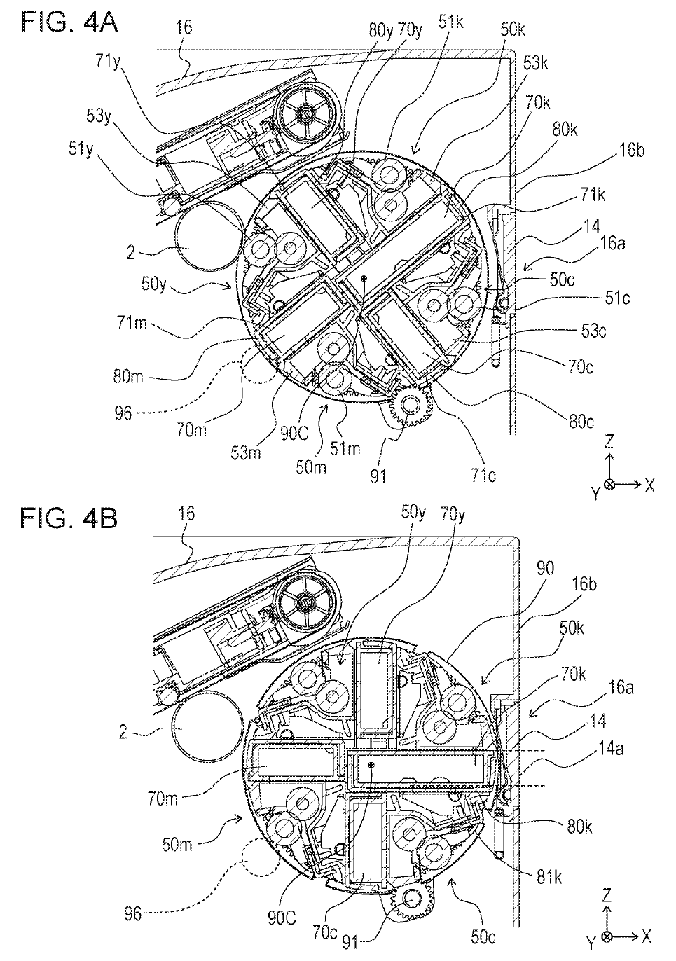

The developing roller 51k of the developing unit 50k is an example of the first developing roller. The developing roller 51m of the developing unit 50m is an example of the second developing roller. The developing frame 53k of the developing unit 50k (FIG. 4A) having the developing-side storage chamber 53a is an example of a first storage frame having a first storage chamber. The developing frame 53m of the developing unit 50m (FIG. 4A) having the developing-side storage chamber 53a is an example of a second storage frame having a second storage chamber. The rotary body 90 is an example of a rotatable rotary including the first developing roller, the second developing roller, the first storage frame having the first storage chamber, and the second storage frame having the second storage chamber. In the present embodiment, the rotary body 90 includes first to fourth developing rollers and first to fourth storage frames.

As will be described later, the toner cartridge 70 is movable relative to the developing frame 53 between a mounted position and a retreat position moved from the mounted position. The discharge opening 71b faces the receiving opening 53b in a state in which the toner cartridge 70 is at the mounted position relative to the developing frame 53. In other words, the toner storage chamber 71a of the toner cartridge 70 and the developing-side storage chamber 53a of the developing unit 50 communicate with each other via the discharge opening 71b and the receiving opening 53b. When toner is supplied from the toner cartridge 70 to the developing unit 50, at least part of the receiving opening 53b is positioned below at least part of the discharge opening 71b.

Then, toner stored in the toner storage chamber 71a is discharged through the discharge opening 71b, and the toner discharged through the discharge opening 71b is put into the developing-side storage chamber 53a through the receiving opening 53b. The toner stored in the developing-side storage chamber 53a is supplied to the developing roller 51 by the supply roller 52. The toner stored in the toner storage chamber 71a is supplied to the developing roller 51 through this route. In other words, the discharge opening 71b is an opening through which toner supplied from the toner storage chamber 71a to the developing unit 50 passes.

The toner cartridge 70 desirably includes a sealing member (first sealing member) (not shown) that covers the discharge opening 71b. The developing unit 50 desirably includes a sealing member (second sealing member) (not shown) that covers the receiving opening 53b.

In a state in which the toner cartridge 70 is not mounted on the developing unit 50, the discharge opening 71b and the receiving opening 53b are desirably covered by the sealing members to suppress the outflow of toner through the discharge opening 71b and the receiving opening 53b.

### Image Forming Operation

The image forming operation in the present embodiment will be described. First, the photoconductor drum 2 is rotated in the direction of the arrow in FIG. 1 (counterclockwise) in synchronization with the rotation of the intermediate transfer belt 10a. Then, the surface of the photoconductor drum 2 is uniformly electrostatically charged by the charge roller 3.

When a color image is formed on a sheet S, the rotary body 90 rotates in the direction of the arrow in FIG. 1 (clockwise) while supporting the developing units 50y, 50m, 50c, and 50k as described below. After that, while the developing rollers 51y, 51m, 51c, and 51k are moved to a developing position one by one, an electrophotographic process is repeatedly performed.

First, the scanner 4 applies a laser beam based on image data corresponding to a yellow image to form an electrostatic latent image corresponding to the yellow image on the surface of the photoconductor drum 2. In parallel with the formation of the electrostatic latent image, the motor M1 rotates the rotary body 90 to cause the rotary body 90 to take the yellow development posture. When the rotary body 90 is in the yellow development posture, the developing roller 51y is at the developing position and develops the electrostatic latent image formed on the photoconductor drum 2 by using yellow toner.

In the present embodiment, each of the developing rollers 51y, 51m, 51c, and 51k is an elastic roller in which a metal shaft is coated with rubber. At the developing position, each of the developing rollers 51y, 51m, 51c, and 51k develops an electrostatic latent image in a state of being in contact with the photoconductor drum 2. In other words, the image forming apparatus 1 in the present embodiment adopts a contact developing method. However, at the developing position, each of the developing rollers 51y, 51m, 51c, and 51k may develop an electrostatic latent image in a state in which there is a gap from the photoconductor drum 2. In other words, the image forming apparatus 1 may adopt a noncontact developing method.

When the yellow toner image is developed, the yellow toner image on the photoconductor drum 2 is primarily transferred to the intermediate transfer belt 10a by the primary transfer roller 11 disposed inside the intermediate transfer belt 10a.

After this, the rotary body 90 is rotated to move the developing rollers 51m, 51c, and 51k in sequence to the developing position, and a toner image of the corresponding color is formed. In other words, after the yellow toner image is formed on the intermediate transfer belt 10a, the rotary body 90 takes the magenta development posture, and a magenta toner image is formed on the intermediate transfer belt 10a. After the magenta toner image is formed on the intermediate transfer belt 10a, the rotary body 90 takes the cyan development posture, and a cyan toner image is formed on the intermediate transfer belt 10a. After the cyan toner image is formed on the intermediate transfer belt 10a, the rotary body 90 takes the black development posture, and a black toner image is formed on the intermediate transfer belt 10a. After the black toner image is formed on the intermediate transfer belt 10a, the rotary body 90 rotates around the rotation axis 90C in the direction of the arrow shown in FIG. 1 (clockwise) to return to the yellow development posture. The color of an image first formed on the intermediate transfer belt 10a is optional. For example, a black toner image may be formed first.

Then, primary transfer is repeated such that four toner images are overlaid on the intermediate transfer belt 10a, with the result that a color image is formed on the intermediate transfer belt 10a. The secondary transfer roller 12 and the cleaning device 13 are not in contact with the intermediate transfer belt 10a until a color image is formed on the intermediate transfer belt 10a.

On the other hand, a sheet S is fed by the pick-up roller 310 from the sheet storage chamber 300 provided at the bottom of the apparatus main body 1A. The sheets S are separated into individual sheets by the feed roller 311 and the separation roller 312 and conveyed to the conveying roller pair 320. The conveying roller pair 320 conveys the fed sheet S to a transfer portion (secondary transfer portion), which is a nip portion between the intermediate transfer belt 10a and the secondary transfer roller 12. The color image on the intermediate transfer belt 10a is transferred to the surface of the conveyed sheet S (secondary transfer).

The sheet S with a color image transferred is conveyed to the fixing unit 40. In the fixing unit 40, the sheet S is heated and pressed to fix the image onto the sheet S. The sheet S having passed through the fixing unit 40 is discharged to the outside of the image forming apparatus 1 as a product.

On the other hand, when a monochrome image is formed on a sheet S, the rotary body 90 takes the black development posture. In this state, after an electrostatic latent image is formed on the surface of the photoconductor drum 2 as a result of electrostatically charging and exposure of the photoconductor drum 2, the electrostatic latent image is developed using black toner by the developing roller 51k positioned at the developing position. The black toner image is primarily transferred to the intermediate transfer belt 10a and then secondarily transferred to a sheet S. The subsequent processes are similar to those in the case of color images.

### Rotary Configuration

The configuration of the rotary body 90 will be described with reference to FIGS. 1, 4A, 4B, and FIG. 5.

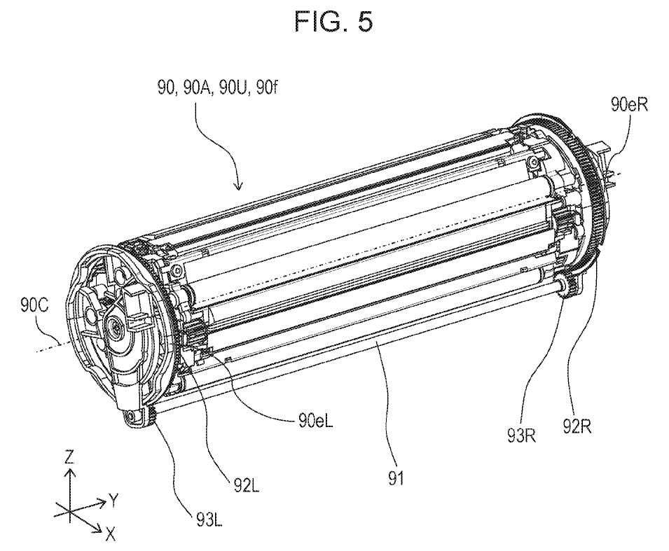

FIGS. 4A and 4B are cross-sectional views that show the rotary body 90 of the image forming apparatus 1 and its surroundings. FIGS. 4A and 4B are cross-sectional views of the apparatus, taken along an imaginary plane perpendicular to the rotation axis 90C of the rotary body 90. FIG. 5 is a perspective view of the rotary body 90.

As described earlier, the toner cartridges 70y to 70k can be attached to and detached from the rotary body 90. A user is able to supply toner to the image forming apparatus 1 by replacing the toner cartridges 70y to 70k when toner inside the toner cartridges 70y to 70k runs out.

As shown in FIG. 1, the apparatus main body 1A includes a frame 16 that accommodates the rotary body 90.

The frame 16 is a main body frame of the image forming apparatus 1 of the present embodiment. The frame 16 is the housing (framework) of the apparatus main body 1A formed of a frame and an exterior member. The frame 16 has a substantially rectangular parallelepiped shape in the present embodiment.

The frame 16 has an opening 16a. More specifically, the frame 16 includes a side surface 16b that extends in a direction that intersects the horizontal direction. The side surface 16b forms at least part of a plus X-side outer appearance surface of the apparatus main body 1A. The opening 16a is disposed at the side surface 16b. The side surface 16b is a side surface disposed downstream of an outlet of the apparatus main body 1A in a discharge direction in which a sheet S with a formed image is discharged through the outlet. A user is able to access the sheet storage chamber 300 from the side surface 16b side of the image forming apparatus 1 to replenish the sheet storage chamber 300 with sheets S or collect a sheet S discharged through the outlet. Therefore, the side surface 16b may be regarded as the front (front surface) of the apparatus main body 1A.

The toner cartridges 70y, 70m, 70c, and 70k can be attached to and detached from the rotary body 90 through the opening 16a. In other words, the toner cartridge 70k may be regarded as an example of a first toner cartridge that stores toner supplied to the first developing roller (developing roller 51k) and that can be attached to and detached from the rotary (rotary body 90) through the opening 16a of the frame 16 of the apparatus main body 1A. The toner cartridge 70m may be regarded as an example of a second toner cartridge that stores toner supplied to the second developing roller (developing roller 51m) and that can be attached to and detached from the rotary (rotary body 90) through the opening 16a of the frame 16 of the apparatus main body 1A.

In the present embodiment, the toner cartridges 70y, 70m, 70c, and 70k are attached to and detached from the rotary body 90 through the opening 16a in a state of being supported by the trays 80y to 80k. In other words, a user is able to attach and detach the toner cartridges 70y to 70k to and from the rotary body 90 via the trays 80y to 80k.

The opening 16a is disposed at the side surface 16b of the frame 16. In the present embodiment, the side surface 16b is a surface that is substantially parallel to the rotation axis 90C of the rotary body 90. Therefore, when the toner cartridge 70 is replaced, the toner cartridge 70 passes through the opening 16a in a direction that intersects (preferably, is orthogonal to) the rotation axis 90C.

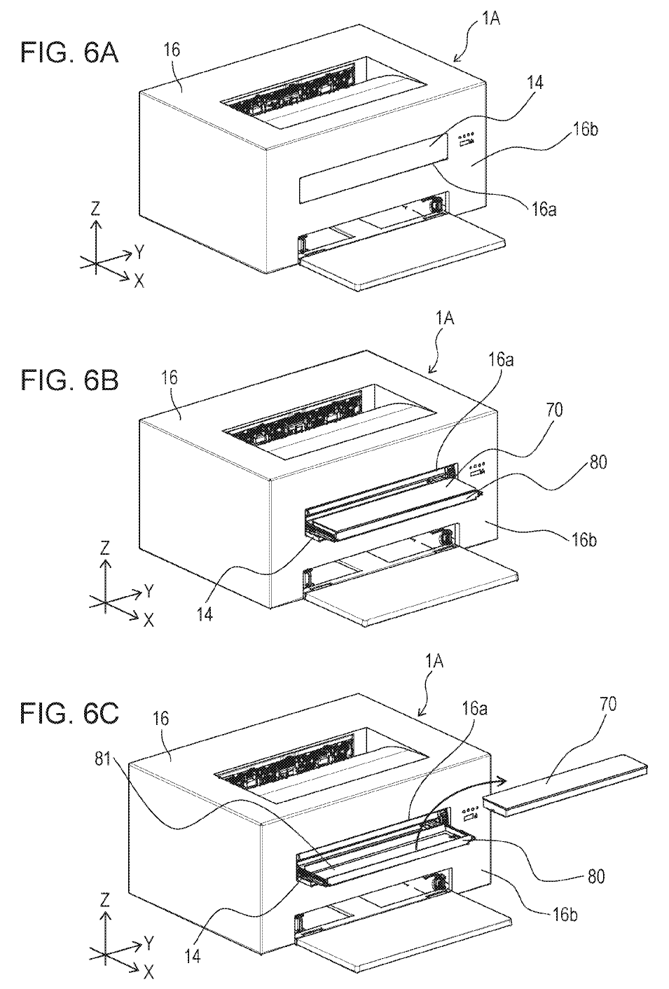

The image forming apparatus 1 includes a door 14 that covers the opening 16a of the frame 16. The door 14 is an opening and closing member movable between a closed position at which the opening 16a is covered (see FIG. 6A) and an open position at which the opening 16a is exposed (see FIGS. 6B and 6C).

As described above, in the present embodiment, the toner cartridge 70 is configured to be attached to and detached from the rotary body 90 via the tray 80. Therefore, the toner cartridge 70 can be stably attached to and detached from the rotary body 90.

More specifically, a user is able to replace the toner cartridge 70 by attaching and detaching the toner cartridge 70 to and from the tray 80 configured to be movable relative to the rotary body 90 (that is, relative to the apparatus main body 1A). When the user directly replaces the toner cartridge by directly removing the toner cartridge from the apparatus main body and inserting a toner cartridge into the apparatus main body, the user is asked to insert the toner cartridge into a predetermined mounted position inside the apparatus main body. In the present embodiment, the tray 80 is movable in the state of supporting the toner cartridge 70 so that the toner cartridge 70 moves to the mounted position. Therefore, a user is able to replace the toner cartridge 70 through easy operation, that is, by putting the toner cartridge 70 on the tray 80, so the operability improves.

The toner cartridge 70 has an elongated shape extending in a longitudinal direction set to the Y direction parallel to the rotation axis 90C of the rotary body 90. In other words, the dimension of the toner cartridge 70 in the longitudinal direction is larger than the height and width in a cross section orthogonal to the longitudinal direction. When the toner cartridge 70 with such an elongated shape is handled, the toner cartridge 70 can be passed through the opening 16a with a short moving distance by disposing the opening 16a at the side surface 16b of the frame 16, which is substantially parallel to the longitudinal direction (Y direction) of the toner cartridge 70. For example, replacing the toner cartridges 70 is easier as compared with removing and inserting the toner cartridges 70 through an opening provided at one-side (+Y-side or -Y-side) side surface of the frame 16 in the longitudinal direction of the toner cartridge 70.

The rotary body 90 can rotate around the rotation axis 90C to take a replacement posture in which detachment of any one of the toner cartridges 70y to 70k from the rotary body 90 is allowed. The posture in which detachment of the toner cartridge 70y is allowed is referred to as a yellow replacement posture. The posture in which detachment of the toner cartridge 70m is allowed is referred to as a magenta replacement posture. The posture in which detachment of the toner cartridge 70c is allowed is referred to as a cyan replacement posture.

The posture in which detachment of the toner cartridge 70k is allowed is referred to as a black replacement posture. The black replacement posture is an example of a first replacement posture in which detachment of the first toner cartridge from the rotary body 90 is allowed. The yellow, magenta, and cyan replacement postures are examples of a second replacement posture in which detachment of the second toner cartridge from the rotary body 90 is allowed. The yellow, magenta, cyan, and black replacement postures may also be referred to as first to fourth replacement postures. These designations are used for the sake of convenience of description and may be interchanged as needed.

The rotary body 90 can sequentially take the yellow, magenta, cyan, and black replacement postures by rotating clockwise in FIG. 1 around the rotation axis 90C. In the present embodiment, the rotary body 90 can alternately switch between the development posture and the replacement posture by rotating clockwise in FIG. 1 around the rotation axis 90C. For example, in FIG. 1, the rotary body 90 is in the black development posture. From this state, when the rotary body 90 rotates clockwise, the posture of the rotary body 90 is switched in the order of a cyan replacement posture, a yellow development posture, a black replacement posture, a magenta development posture, a yellow replacement posture, a cyan development posture, and a magenta replacement posture. When the rotary body 90 rotates clockwise from the magenta replacement posture, the rotary body 90 returns to the black development posture. In other words, the rotary body 90 can rotate one full rotation (360°) or more clockwise.

FIG. 4A shows the cross section of the rotary body 90 in a development posture (specifically, in the yellow development posture). FIG. 4B shows the cross section of the rotary body 90 in a replacement posture (specifically, the black replacement posture).

As shown in FIGS. 4A and 4B, four trays 80y to 80k are attached to the rotary body 90. The trays 80y to 80k respectively hold the toner cartridges 70y to 70k. In FIGS. 4A and 4B, the trays 80y to 80k are accommodated inside the rotary body 90, and this state may be regarded as a state in which the toner cartridges 70y to 70k are mounted on the developing units 50y, 50m, 50c, and 50k.

As described above, the toner cartridge 70 is movable relative to the developing frame 53 of the developing unit 50 between the mounted position and the retreat position moved from the mounted position. In other words, the first toner cartridge (toner cartridge 70k) is movable relative to the first storage frame (developing frame 53k) between a first mounted position and a first retreat position. The second toner cartridge (toner cartridge 70m) is movable relative to the second storage frame (developing frame 53m) between a second mounted position and a second retreat position.

The discharge opening 71b and the receiving opening 53b face each other as shown in FIG. 3 in a state in which the toner cartridge 70 is at the mounted position relative to the developing frame 53. In this state, the toner cartridge 70 is configured to supply toner to the developing-side storage chamber 53a through the receiving opening 53b (the opening of the storage frame).

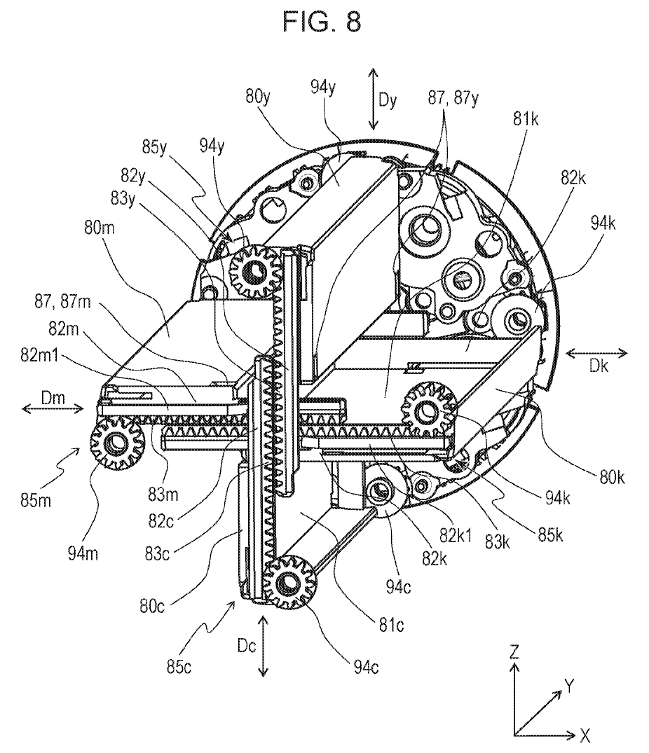

The apparatus main body 1A includes a moving device 85 configured to move the toner cartridge 70 from the mounted position to the retreat position relative to the rotary body 90 (more specifically, relative to the developing frame 53 of the developing unit 50). The moving device 85 will be described later with reference to FIG. 8 and the like. In the present embodiment, a plurality of moving devices 85y to 85k corresponding to the plurality of toner cartridges 70y to 70k are disposed in the rotary body 90. The trays 80y to 80k may be regarded as parts of the moving devices 85y to 85k.

In the present embodiment, the toner cartridge 70k storing black toner has a larger size and can store a larger amount of toner than the toner cartridges 70y to 70c respectively storing yellow toner, magenta toner, and cyan toner. In other words, the first toner cartridge can store a first amount of toner, and the second toner cartridge can store a second amount of toner, so the first amount is regarded as being greater than the second amount.

Specifically, the length of the black toner cartridge 70k in a first radial direction relative to the rotation axis 90C of the rotary body 90 is greater than the length of the magenta toner cartridge 70m in a second radial direction. Here, the first radial direction refers to the radial direction of the rotary body 90 (the radial direction of an imaginary circle centered on the rotation axis 90C) and is a direction in which the toner cartridge 70k extends relative to the rotation axis 90C when viewed in the direction of the rotation axis 90C. The second radial direction is the radial direction of the rotary body 90 and is a direction in which the toner cartridge 70m extends relative to the rotation axis 90C when viewed in the direction of the rotation axis 90C. Similarly, the length of the black toner cartridge 70k in the first radial direction is greater than the length of the toner cartridges 70y, 70c in the radial directions corresponding to the other toner cartridges 70y, 70c.

Therefore, the tray 80k that holds the black toner cartridge 70k is lar8085k with different sizes are disposed inside the rotary body 90. In other words, the toner cartridge 70k, which is an example of the first toner cartridge, and the toner cartridge 70y, which is an example of the second toner cartridge smaller in size than the first toner cartridge, can be attached to and detached from the rotary body 90. In accordance with this, the rotary body 90 includes the tray 80k, which is an example of the first support member supporting the first toner cartridge, and the tray 80y, which is an example of the second support member smaller in size than the first support member. The toner cartridges 70m, 70c, which are examples of the third toner cartridge and the fourth toner cartridge smaller in size than the first toner cartridge, can be attached to and detached from the rotary body 90. In accordance with this, the rotary body 90 includes the trays 80m, 80c, which are examples of the third support member and the fourth support member smaller in size than the first support member.

Here, the rotational drive of the rotary body 90 will be described with reference to FIG. 5. As shown in FIG. 5, disk gears 92L and 92R are respectively provided at both ends of the rotary body 90. Rotary drive gears 93L and 93R are respectively drivably connected to both ends of a pivot shaft 91. Here, the driving force of the motor M1 is transmitted to the rotary drive gear 93R by a drive transmission mechanism. Subsequently, the rotary body 90 is rotationally driven by the driving force transmitted to the disk gears 92L and 92R by the rotary drive gears 93L and 93R. The rotary body 90 rotates around the rotation axis 90C clockwise in FIG. 1.

The rotary body 90 is supported so as to be pivotable about the pivot shaft 91. The rotary body 90 is urged by an urging member (not shown) in a counterclockwise direction in FIGS. 4A and 4B about the pivot shaft 91. This direction may be regarded as the direction in which each of the developing rollers 51y to 51k approaches the photoconductor drum 2. As a result, in a state in which the rotary body 90 is in the development posture, each of the developing rollers 51y to 51k contacts the photoconductor drum 2.

On the other hand, as shown in FIG. 5, rotary cams 90eL and 90eR are provided at both ends of the rotary body 90. When the rotary body 90 rotates clockwise in FIGS. 4A and 4B about the rotation axis 90C, the rotary cams 90eL and 90eR contact a roller 96 (FIGS. 4A and 4B) supported by the frame 16. Then, the rotary body 90 moves in a clockwise direction in FIGS. 4A and 4B about the pivot shaft 91. This direction may be regarded as a direction in which each of the developing rollers 51y to 51k moves away from the photoconductor drum 2. This direction may be regarded as a direction in which the rotary body 90 approaches the opening 16a of the frame 16 and the door 14.

Thus, when the rotary body 90 rotates to switch from the development posture to the replacement posture, the rotary body 90 pivots about the pivot shaft 91. In a state in which the rotary body 90 is in the replacement posture, the developing roller 51 separates from the photoconductor drum 2.

As shown in FIG. 4B, in the black replacement posture, the toner cartridge 70k stops at a position at which the toner cartridge 70k faces the opening 16a and the door 14 both provided at the side surface 16b of the apparatus main body 1A. From this state, when the tray 80k is slid from the mounted position for the developing unit 50k to the outside of the rotary body 90, a user is able to replace the toner cartridge 70k.

### Replacement Operation of Toner Cartridge

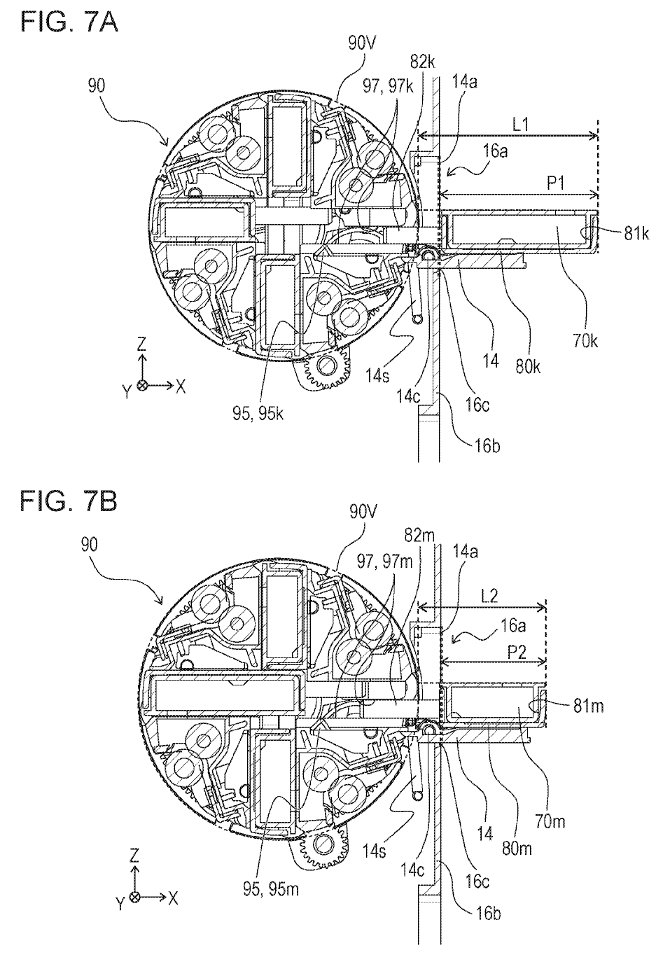

A toner cartridge replacement operation will be described with reference to FIGS. 4A, 6A to 6C, 7A, and FIG. 7B. FIGS. 6A to 6C are outer appearance views of the apparatus main body 1A. FIGS. 7A and 7B are cross-sectional views around the rotary body 90 when the toner cartridge is replaced. FIGS. 7A and 7B are cross-sectional views of the apparatus, taken along an imaginary plane perpendicular to the rotation axis 90C of the rotary body 90.

FIG. 6A is the outer appearance of the apparatus main body 1A during image forming operation and in a standby state. During the image forming operation, the image forming apparatus 1 is performing a series of operations in which the image forming apparatus 1 feeds a sheet S, forms an image on the sheet S, and then discharges the sheet S as a product. The standby state is a state in which the image forming apparatus 1 can start the image forming operation when receiving an image forming instruction (print instruction) and is a state of waiting for an image forming instruction from a user. As shown in FIG. 6A, the door 14 is in a closed state during the image forming operation and in the standby state.

FIG. 6B is the outer appearance of the apparatus main body 1A when the toner cartridge is replaced. When the toner cartridge is replaced, the door 14 is placed in the open state, and the tray 80 and the toner cartridge 70 are moved to the outside of the apparatus main body 1A.

The toner cartridge 70 is movable relative to the developing frame 53 of the developing unit 50 between the mounted position and the retreat position moved from the mounted position. The discharge opening 71b and the receiving opening 53b face each other as shown in FIG. 3 in a state in which the toner cartridge 70 is at the mounted position relative to the developing frame 53. As shown in FIGS. 4A and 4B, the rotary body 90 is configured to rotate around the rotation axis 90C to take a development posture and a replacement posture in a state in which the toner cartridge 70 is at the mounted position.

The toner cartridge replacement operation will be described. Initially, the user instructs the control unit of the apparatus main body 1A to perform a toner cartridge replacement operation. An instruction for a toner cartridge replacement operation is issued in response to an input through an operation panel (operation unit) provided, for example, on the apparatus main body 1A.

When the control unit receives an instruction for a toner cartridge replacement operation, the rotary body 90 rotates to the replacement posture of the toner cartridge 70 to be replaced (empty toner cartridge 70) and stops. In other words, the control unit rotates the rotary body 90 to the replacement posture of the toner cartridge designated in the instruction for a toner cartridge replacement operation (the black replacement posture for replacing the black toner cartridge 70k in FIG. 4B). In the replacement posture, the tray 80 supporting the designated toner cartridge 70 for replacement faces the opening 16a of the frame 16 of the apparatus main body 1A.

For example, the rotary body 90 in FIG. 4A is in the yellow development posture in which the yellow developing roller 51y faces the photoconductor drum 2. At this time, the black toner cartridge 70k and the corresponding tray 80k do not need to face the opening 16a and the door 14. In other words, the toner cartridge 70 and the tray 80 do not need to face the opening 16a and the door 14 when the rotary body 90 is in a replacement posture other than the replacement posture of the intended toner cartridge, or a development posture. Therefore, it is sufficient that the opening 16a has a size large enough for each toner cartridge 70 to pass through individually. When the rotary body 90 rotates from the yellow development posture by a predetermined angle clockwise in the drawing, the black toner cartridge 70k and the corresponding tray 80k face the opening 16a and the door 14 as shown in FIG. 4B.

Here, "the tray 80 faces the opening 16a" means that the tray 80 is positioned so that the tray 80 is movable to the outside of the apparatus main body 1A through the opening 16a. In other words, when the tray 80 faces the opening 16a, the tray 80 is moved to the radially outer side of the rotary body 90 by a movement mechanism (described later), with the result that the tray 80 and the toner cartridge 70 supported by the tray 80 can protrude to the outside of the apparatus main body 1A. In FIG. 4A, none of the trays 80y to 80k are facing the opening 16a. In FIG. 4B, only the black tray 80k faces the opening 16a, while the other trays 80y to 80c do not face the opening 16a.

When the rotary body 90 is positioned in a replacement posture, the tray 80 supporting the toner cartridge 70 to be replaced is moved toward the outside of the apparatus main body 1A by the motor M2.

As a result, the toner cartridge 70 to be replaced moves from the mounted position to the retreat position relative to the rotary body 90. As shown in FIGS. 6B, 6C, 7A, and FIG. 7B, the tray 80 and the toner cartridge 70 to be replaced, supported by the tray 80, protrude to the outside of the apparatus main body 1A through the opening 16a.

More specifically, the tray 80 is movable relative to the rotary body 90 between a storage position and an eject position. The storage position is a position at which the tray 80 is stored in the rotary body 90. The eject position is a position at which the tray 80 protrudes to the outside of the rotary body 90 and the toner cartridge 70 is allowed to be removed from the tray 80 (detachment position, replaceable position). Examples of the storage position include the positions of the trays 80y to 80k in FIGS. 4A and 4B. Examples of the eject position include the positions of the tray 80 in FIGS. 6B and 6C, the tray 80k in FIG. 7A, and the tray 80m in FIG. 7B.

When the tray 80 is at the storage position, the toner cartridge 70 attached to the tray 80 is positioned at the mounted position. When the tray 80 is at the eject position, the toner cartridge 70 attached to the tray 80 is positioned at the retreat position.

Here, as shown in FIGS. 7A and 7B, the rotary body 90 has protrusions 95 to hold the tray 80 at the storage position and to hold the toner cartridge 70 at the mounted position. As shown in FIG. 8, the tray 80 has recesses 87 that fit the protrusions 95. FIGS. 7A and 7B show protrusions 95k and 95m corresponding to the trays 80k and 80m, and FIG. 8 shows recesses 87y and 87m of the trays 80y and 80m; however, the protrusions 95 and the recesses 87 are provided for each of the trays 80y to 80k. The protrusions 95 are preferably urged in a direction to engage with the recesses 87.

When the protrusions 95 fit the recesses 87 of the tray 80, the tray 80 is locked to the rotary frame 90f. This makes the tray 80 stay at the storage position even when the rotary body 90 rotates and prevents the movement of the toner cartridge 70 from the mounted position. When the tray 80 is moved between the storage position and the eject position by the moving device (described later), the protrusions 95 can be configured to be moved by the tray 80 to come off from the recesses 87.

In the present embodiment, the door 14 is pivotally supported relative to the apparatus main body 1A. As shown in FIG. 7A, the door 14 is urged from the open position toward the closed position by a spring 14s. The spring 14s is, for example, a tension spring that urges the door 14 to generate a moment in the counterclockwise direction in FIGS. 7A and 7B about a support shaft 14c of the door 14.

The tray 80 pushes the door 14 to place the door 14 in the open state (the state shown in FIG. 6B). This state can also be referred to as a state in which the tray 80 is supported by the door 14. The door 14 supports at least part of the tray 80 protruding to the outside of the apparatus main body 1A, with the result that the toner cartridge 70 can be further stably supported. In other words, when the first toner cartridge (toner cartridge 70k) is at the first retreat position, the opening and closing member (door 14) at the open position supports the first support member (tray 80k). When the second toner cartridge (any one of the toner cartridges 70y to 70c) is at the second retreat position, the opening and closing member (door 14) at the open position supports the second support member (a corresponding one of the trays 80y to 80c).

The door 14 is configured to contact a part (for example, a lower edge 16c of the opening 16a) of the frame 16 of the apparatus main body 1A at the open position and not to pivot downward beyond the open position. When the tray 80 is pulled back from the outside to the inside of the apparatus main body 1A, the door 14 returns to the closed position due to the urging force of the spring 14s.

The toner cartridge 70 is detachably held by the tray 80. Therefore, as shown in FIG. 6C, a user is able to perform work for detaching the toner cartridge 70 from the tray 80 and attaching a new toner cartridge 70 (replacement work). When the plurality of toner cartridges 70 are replaced, replacement work can be performed by repeating the above-described actions.

FIGS. 7A and 7B show a cross-section around the rotary body 90 when the toner cartridge is replaced. FIG. 7A shows a state when the black toner cartridge 70k is replaced. FIG. 7B shows a state when the magenta toner cartridge 70m is replaced.

The image forming apparatus 1 includes moving devices 85 (FIG. 8) that respectively move the toner cartridges 70 from the mounted position to the retreat position. In the present embodiment, it may be understood that each of the moving devices 85 includes the tray 80. The moving device 85k including the tray 80k may be regarded as an example of a first moving device including the first support member. The moving device 85m including the tray 80m may be regarded as an example of a second moving device including the second support member.

Even when the toner cartridge 70 is at the retreat position, the tray 80 is still connected to the rotary body 90 (supported by the rotary body 90). To easily detach the toner cartridge 70 from the rotary body 90, the length by which the toner cartridge 70 protrudes from the rotary body 90 at the retreat position is preferably long. Since the toner cartridge 70 is configured to be attachable to and detachable from the rotary body 90 via the tray 80, the toner cartridge 70 can be stably supported by the tray 80 even when the length by which the toner cartridge 70 protrudes from the rotary body 90 is long.

The moving direction of the toner cartridge 70 when the toner cartridge 70 moves from the mounted position to the retreat position is referred to as a retreat direction. In the present embodiment, the retreat direction of the toner cartridge 70 is a direction that intersects the direction of the rotation axis 90C (Y direction). Therefore, as shown in FIGS. 7A and 7B, when viewed in the direction of the rotation axis 90C (Y direction), the retreat direction of the toner cartridge 70 is a direction orthogonal to the direction of the rotation axis 90C (Y direction). The retreat direction of the toner cartridge 70 may be regarded as a direction outward in the radial direction of the rotary body 90 (a direction away from the rotation axis 90C).

As shown in FIGS. 7A and 7B, because the user detaches the toner cartridge 70 from the rotary body 90, at least part of the toner cartridge 70 preferably protrudes from the rotary body 90 when the toner cartridge 70 is detached. In the present embodiment, when the toner cartridge 70 is at the retreat position, the entire toner cartridge 70 protrudes from the rotary body 90.

When the rotary body 90 rotates around the rotation axis 90C, the rotation trajectory of the rotary body 90 can be considered to coincide with the circumscribed circle (the imaginary circle 90V indicated by the dashed line in FIGS. 7A and 7B) of the rotary body 90 about the rotation axis 90C. When the toner cartridge 70 is at the retreat position, a half or more of the length of the toner cartridge 70 in the retreat direction is preferably placed outside of the rotation trajectory of the rotary body 90. In other words, when viewed in the rotation axis direction of the rotary, a half or more of the total length of the toner cartridge is preferably positioned outside of the rotation trajectory of the rotary in the moving direction of the toner cartridge from the mounted position toward the retreat position in a state in which the toner cartridge is at the retreat position. This applies to each of the toner cartridges 70 including the toner cartridge 70k as an example of a first cartridge and the toner cartridge 70m as an example of a second cartridge. In the present embodiment, as shown in FIGS. 7A and 7B, when the toner cartridge 70 is at the retreat position, the entire toner cartridge 70 is positioned outside of the rotation trajectory (imaginary circle 90V) of the rotary body 90.

Furthermore, to make it easier for the user to grasp the toner cartridge 70, when the toner cartridge 70 is at the retreat position, at least part of the toner cartridge 70 is preferably positioned outside of the image forming apparatus 1 (outside of the apparatus main body 1A). Here, the "outside of the machine" means a space outside of the image forming apparatus 1 (outside of the apparatus main body 1A) when the image forming apparatus 1 is used in, for example, an image forming operation on a sheet S or the like.

In the present embodiment, the outer appearance surface of the apparatus main body 1A is formed by the outer appearance surface of the frame 16. In other words, the "outside of the machine" may be regarded as the outside of the frame 16. Therefore, a state in which at least part of the toner cartridge 70 is positioned outside of the machine may be regarded as a state in which at least part of the toner cartridge 70 protrudes from the opening 16a of the frame 16 of the apparatus main body 1A toward the outside of the frame 16.

In the present embodiment, when the door 14 is at the closed position, the opening 16a of the frame 16 of the apparatus main body 1A is covered by the door 14. Part of the outer appearance surface of the apparatus main body 1A is formed by the outer appearance surface 14a of the door 14 at the closed position. In this case, "outside of the machine" refers to outside of the outer appearance surface 14a of the door 14 at the closed position. In other words, assume that the position of the outer appearance surface 14a of the door 14 at the closed position is an outer appearance position, when the toner cartridge 70 is at the retreat position, at least part of the toner cartridge 70 is positioned outside of the apparatus main body 1A beyond the outer appearance position.

In other words, if the door 14 is at the closed position, at least part of the toner cartridge 70 is positioned in a space outside of the apparatus main body 1A. In the retreat direction of the toner cartridge 70, at least part of the toner cartridge 70 is positioned downstream of the outer appearance position.

Assume that the side surface 16b having the opening 16a is the front of the apparatus main body 1A, when the toner cartridge 70 is at the retreat position, at least part of the toner cartridge 70 may be regarded as protruding further to the front beyond the front-side outer appearance surface of the apparatus main body 1A. In this case, a user is able to access the toner cartridge 70 from the front side of the image forming apparatus to easily replace the toner cartridge 70.

When the toner cartridge 70 is at the retreat position, a half or more of the length of the toner cartridge 70 in the retreat direction is preferably placed outside of the machine. In other words, when viewed in the rotation axis direction of the rotary, a half or more of the total length of the toner cartridge is preferably positioned outside of the main body frame in the moving direction of the toner cartridge from the mounted position toward the retreat position in a state in which the toner cartridge is at the retreat position. This applies to each of the toner cartridges 70 including the toner cartridge 70k as an example of the first cartridge and the toner cartridge 70m as an example of the second cartridge. When the toner cartridge 70 is at the retreat position, the entire toner cartridge 70 is preferably placed outside of the machine. In the present embodiment, the front-side outer appearance surface of the apparatus main body 1A is formed by the outer appearance surface 14a of the door 14 and the side surface 16b; however, the configuration of the door 14 is not limited thereto. For example, the size of the door 14 may be a size covering the entire side surface 16b. In this case, the front-side outer appearance surface of the apparatus main body 1A is formed by the outer appearance surface 14a of the door 14.

The tray 80 includes a cartridge holding portion 81 that holds the toner cartridge 70 (see FIGS. 3 and 6C). The cartridge holding portion 81 is a mounted portion on which the toner cartridge 70 is mounted. When the tray 80 is at the eject position, the entire cartridge holding portion 81 is preferably positioned outside of the rotation trajectory of the rotary body 90 in the retreat direction. When the tray 80 is at the eject position, a half or more of the length of the cartridge holding portion 81 is preferably positioned outside of the machine in the retreat direction.

As described earlier, the toner cartridge 70k and the tray 80k are larger in size than the other toner cartridges 70y to 70c and the other trays 80y to 80c. Therefore, in the present embodiment, as shown in FIGS. 7A and 7B, the amount of movement of the tray 80 during toner cartridge replacement is changed according to the size of the toner cartridge 70.

Specifically, as shown in FIG. 7A, when the tray 80k (first support member) moves from the storage position (first storage position) to the eject position (first eject position), the moving distance is L1. When the tray 80m (second support member) moves from the storage position to the eject position (second eject position), the moving distance is L2. FIG. 7B shows a state in which the toner cartridge 70m and the tray 80m have moved, and, when the trays 80y, 80c move from the storage position to the eject position, the moving distance is also L2. At this time, L1 is greater than L2. In other words, the moving distance of the first support member when the first toner cartridge moves from the first mounted position to the first retreat position may be regarded as being greater than the moving distance of the second support member when the second toner cartridge moves from the second mounted position to the second retreat position.

As shown in FIG. 7A, in a state in which the tray 80k is at the eject position and the toner cartridge 70k is at the retreat position, the toner cartridge 70k protrudes from the outer appearance surface of the apparatus main body 1A to the outside of the machine by a distance P1. In the present embodiment, the tray 80k also protrudes from the outer appearance surface of the apparatus main body 1A to the outside of the machine by a distance P1.

As shown in FIG. 7B, in a state in which the tray 80m is at the eject position and the toner cartridge 70m is at the retreat position, the toner cartridge 70m protrudes from the outer appearance surface of the apparatus main body 1A to the outside of the machine by a distance P2. In the present embodiment, the tray 80m also protrudes from the outer appearance surface of the apparatus main body 1A to the outside of the machine by a distance P2. The toner cartridges 70y and 70c also protrude from the outer appearance surface of the apparatus main body 1A to the outside of the machine by a distance P2.

The distance P1 is greater than the distance P2. In other words, the length by which the first toner cartridge at the first retreat position protrudes from the opening 16a of the apparatus main body 1A is defined as a first length (P1), and the length by which the second toner cartridge at the second retreat position protrudes from the opening 16a is defined as a second length (P2). In this case, the first length may be regarded as being greater than the second length.

The smaller toner cartridges 70y to 70c as compared with the toner cartridge 70k are preferable in terms of strength when the distance P2 by which the toner cartridge protrudes to the outside of the machine at the retreat position is less than the distance P1 by which the toner cartridge 70k protrudes to the outside of the machine at the retreat position. This is due to the following reasons. When the toner cartridge 70 is at the retreat position, at least part of the toner cartridge 70 protrudes to the outside of the rotation trajectory of the rotary body 90 or to the outside of the machine from the outer appearance surface of the apparatus main body 1A. At this time, the tray 80 supports the weight of the toner cartridge 70 in a state of being supported by the rotary body 90 in a cantilever manner. Therefore, as the distance P2 by which the toner cartridges 70y to 70c protrude to the outside of the machine at the retreat position is reduced, the load on the trays 80y to 80c and guide portions 97 of the rotary body 90, which support the trays 80y to 80k, can be reduced. Since the toner cartridges 70y to 70c are smaller in size than the toner cartridge 70k, even when the distance P2 is made less than the distance P1, it is possible to maintain the operability of cartridge replacement for the trays 80y to 80c.

### Tray Arrangement in Rotary

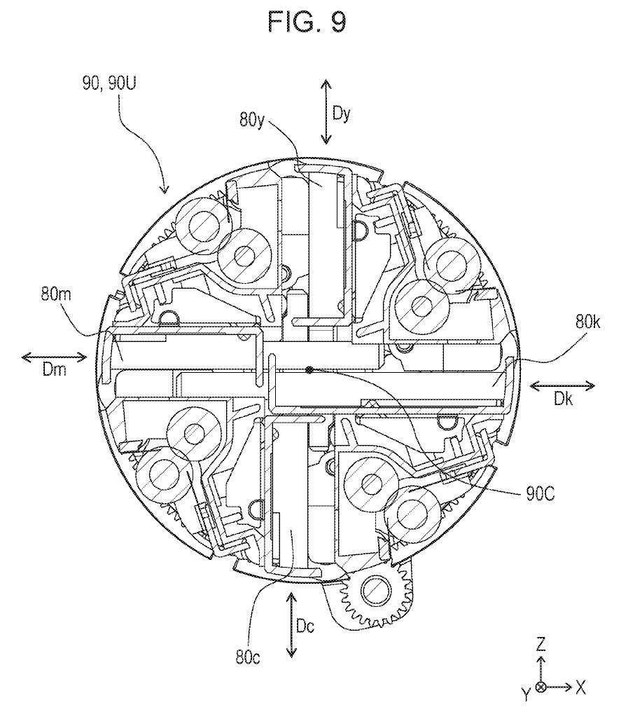

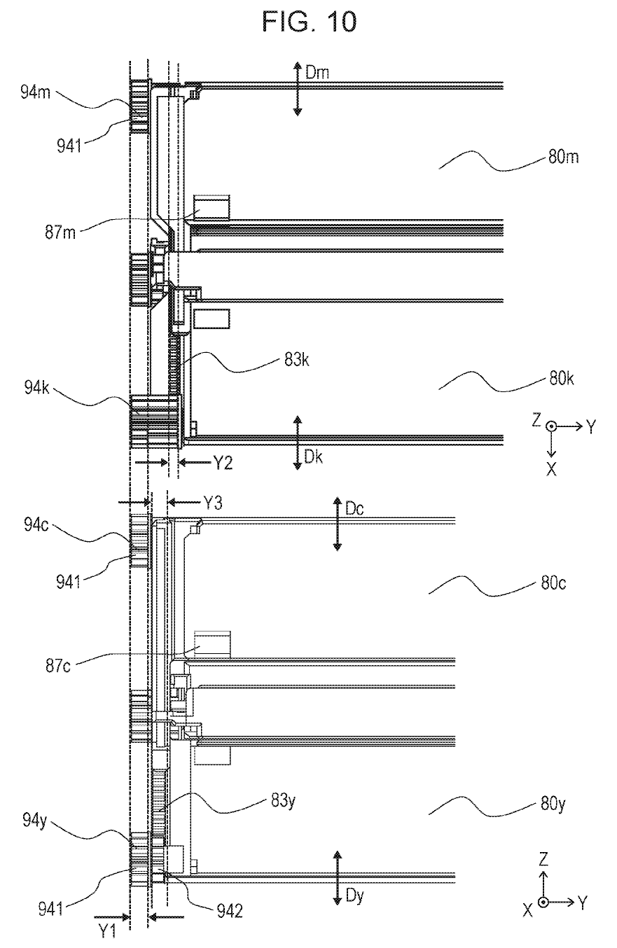

The arrangement of the trays 80y to 80k in the rotary body 90 will be described with reference to FIGS. 8, 9, and 10. FIG. 8 is a perspective view of the arrangement of the trays 80y to 80k in the rotary body 90. FIG. 9 is a cross-sectional view of the arrangement of the trays 80y to 80k in the rotary body 90. FIG. 10 is a view of the arrangement of members on one end side of the trays 80y to 80k in the Y direction. FIG. 9 is a cross-sectional view of the rotary body 90, taken along an imaginary plane perpendicular to the rotation axis 90C of the rotary body 90. The upper half of FIG. 10 is a view of the rotary body 90 and the trays 80m and 80k from the upper side (+Z side) of FIG. 8, and the lower half of FIG. 10 is a view of the rotary body 90 and the trays 80c and 80y from the left side (-X side) of FIG. 8.

As shown in FIG. 8, each of the trays 80y to 80k includes a corresponding one of the cartridge holding portions 81y to 81k and a corresponding one of pairs of guided portions 82y to 82k.

The toner cartridges 70y to 70k are respectively mounted on the cartridge holding portions 81y to 81k. Each of the cartridge holding portions 81y to 81k stores at least part of a corresponding one of the toner cartridges 70y to 70k, mounted thereon.

Each of the pairs of guided portions 82y to 82k is provided at both ends of a corresponding one of the trays 80y to 80k so as to sandwich a corresponding one of the cartridge holding portions 81y to 81k in the Y direction. Each of the guided portions 82y to 82k is an elongated member extending in a direction orthogonal to the rotation axis of the rotary body 90.

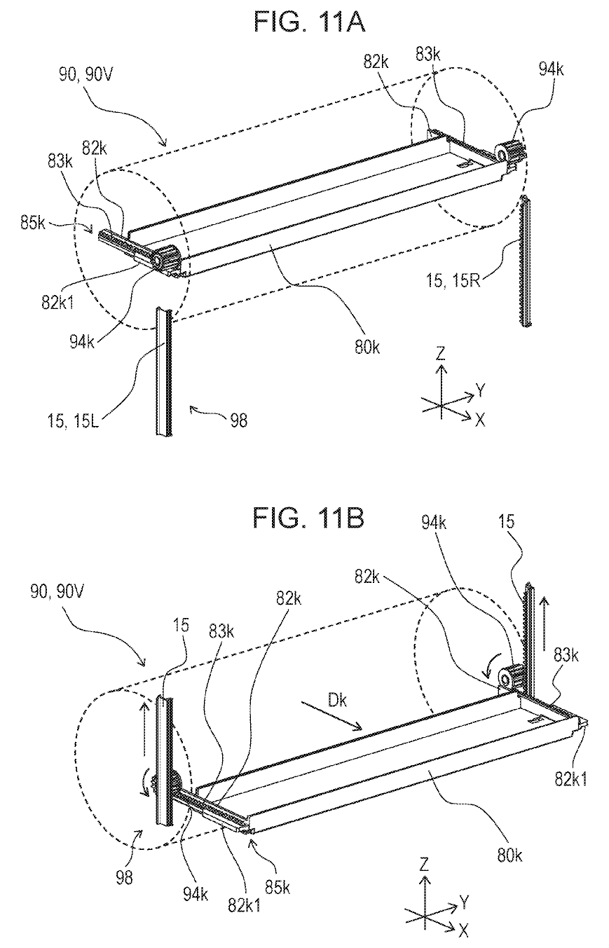

In the present embodiment, a reinforcement rib 82k1 is formed on part of the guided portion 82k in a moving direction Dk of the tray 80k, and a reinforcement rib 82m1 is formed on part of the guided portion 82m in a moving direction Dm of the tray 80m (see also FIGS. 11A and 11B). Each of the reinforcement ribs 82k1 and 82m1 has an elongated rib shape (projection) extending outward from a corresponding one of the guided portions 82k and 82m provided at each end of a corresponding one of the trays 80k and 80m in the Y direction and extends in a corresponding one of the moving directions Dk and Dm of the trays 80k and 80m. With the reinforcement ribs 82k1 and 82m1, the rigidity of the guided portions 82k and 82m improves.

In the present embodiment, the lengths of the reinforcement ribs 82m1 and 82k1 are limited to avoid interference with the guided portions 82y and 82c. However, if there is no interference with the guided portions 82y and 82c, the reinforcement ribs 82m1 and 82k1 may be provided along the entire lengths of the guided portions 82m and 82k. Reinforcement ribs may be added to the guided portions 82y and 82c. When the rigidity of the guided portions 82m and 82k is sufficient, the reinforcement ribs 82m1 and 82k1 do not need to be provided.

Rack portions 83y to 83k (racks) are respectively formed at the guided portions 82y to 82k. Pinions 94y to 94k are rotatably held in the rotary body 90. The pinions 94y to 94k are respectively drivably in mesh with the rack portions 83y to 83k.

The rack portions 83y to 83k and the pinions 94y to 94k are respectively parts of the moving devices 85y to 85k configured to move the toner cartridges 70y to 70k from the mounted position to the retreat position. The rack portions 83y to 83k and the pinions 94y to 94k may be regarded as part of a driven device driven by the drive device 98 of the apparatus main body 1A. The pinions 94y to 94k may be regarded as rotating members (rotary members) that rotate to move the trays 80y to 80k relative to the rotary body 90.

The pinions 94y to 94k and the rack portions 83y to 83k function as driven units for the moving devices 85y to 85k of the rotary body 90 to receive driving force from the drive device 98 of the apparatus main body 1A. The pinion 94k and the rack portion 83k are examples of a first pinion and a first rack that constitute at least part of a first driven unit of the first moving device. The pinion 94m and the rack portion 83m are examples of a second pinion and a second rack that constitute at least part of a second driven unit of the second moving device.

The rotary body 90 has the guide portions 97 that respectively engage with the guided portions 82y to 82k (see FIGS. 7A and 7B). FIG. 7A shows the guide portion 97 (97k) that engages with the guided portion 82k of the tray 80k, and FIG. 7B shows the guide portion 97 (97m) that engages with the guided portion 82m of the tray 80m. The rotary body 90 includes similar guide portions that respectively engage with the guided portions 82y and 82c of the trays 80y and 80c. FIGS. 7A and 7B show the guide portion 97 provided on one side (+Y side) of the rotary body 90 in the Y direction; however, a similar guide portion 97 is also provided on the other side (-Y side) of the rotary body 90 in the Y direction.

When the tray 80 moves between the storage position and the eject position, the guide portion 97 maintains engagement with the guided portion 82 at least in part of the moving range and guides the moving direction of the tray 80. In the present embodiment, the guide portion 97 maintains engagement with the guided portion 82k over the entire moving range between the storage position and the eject position of the tray 80k. In the present embodiment, the guide portion 97 maintains engagement with the guided portion 82m over the entire moving range between the storage position and the eject position of the tray 80m.

As shown in FIGS. 8 and 9, four trays 80y to 80k are disposed so as to overlap each other in the rotary body 90, as will be specifically described below.

When the pinions 94y to 94k rotate, the rack portions 83y to 83k and the trays 80y to 80k move relative to the rotary body 90. As shown in FIG. 9, four trays 80y to 80k are disposed in the rotary body 90 such that the moving directions of the four trays 80y to 80k are rotated by 90 degrees. Therefore, the pair of tray 80y and tray 80c and the pair of tray 80m and tray 80k are each held so as to be slidable substantially in the same direction (parallel direction). The moving direction of each of the trays 80y to 80k during sliding is regulated by the engagement of a corresponding one of the guided portions 82y to 82k with a corresponding one of the guide portions 97.

Each of the trays 80y to 80k moves to the outside of the machine through the opening 16a. When each of the trays 80y to 80k moves to the outside of the machine through the opening 16a, the moving direction of each tray is substantially the same direction (parallel).

As shown in FIG. 9, in the moving direction Dk of the tray 80k, the range in which the tray 80k is placed is disposed so as to overlap the range in which the tray 80y is placed and the range in which the tray 80c is placed. In the moving direction Dk of the tray 80k, the range in which the tray 80k is placed overlaps the rotation axis 90C of the rotary body 90. In other words, the toner cartridge 70k held by the cartridge holding portion 81k of the tray 80k may be regarded as overlapping the rotation axis 90C of the rotary body 90 (FIG. 4B).

On the other hand, in the moving direction Dm of the tray 80m, the range in which the tray 80m is placed is disposed with an offset so as not to overlap the range in which the tray 80y is placed or the range in which the tray 80c is placed. Furthermore, in the moving direction Dy of the tray 80y, the range in which the tray 80y is placed is disposed with an offset so as not to overlap the range in which the tray 80m is placed or the range in which the tray 80k is placed. Similarly, in the moving direction Dc of the tray 80c, the range in which the tray 80c is placed is disposed with an offset so as not to overlap the range in which the tray 80m is placed or the range in which the tray 80k is placed.

The positional relationship among the trays 80 can also be described as follows. When viewed in the moving direction Dy of the tray 80y, the tray 80y overlaps the tray 80k; however, the tray 80y does not overlap the tray 80m. When viewed in the moving direction Dm of the tray 80m, the tray 80m overlaps the tray 80k; however, the tray 80m does not overlap the tray 80y or the tray 80c. When viewed in the moving direction Dc of the tray 80c, the tray 80c overlaps the tray 80k; however, the tray 80c does not overlap the tray 80m.

Here, the phrase "two elements (members, components, units, or the like) overlap each other when viewed in a specific direction" means that, when each element is perpendicularly projected onto an imaginary plane perpendicular to the specific direction, the projection area of one element and the projection area of the other element at least partially overlap each other.

As shown in FIGS. 8 and 10, in the direction of the rotation axis 90C (Y direction), the range in which the rack portion 83m and the guided portion 82m are placed at least partially overlaps the range in which the rack portion 83k and the guided portion 82k are placed. In other words, in the present embodiment, in the rotation axis direction of the rotary (Y direction), the range in which the first rack (rack portion 83k) is placed at least partially overlaps the range in which the second rack (rack portion 83m) is placed. Therefore, as compared with the arrangement in which the rack portion 83m and the guided portion 82m do not overlap the rack portion 83k and the guided portion 82k, the rack portions 83m and 83k and the guided portions 82m and 82k can be disposed in a space-saving manner in the Y direction.

In the direction of the rotation axis 90C (Y direction), the range in which the rack portion 83y and the guided portion 82y are placed at least partially overlaps the range in which the rack portion 83c and the guided portion 82c are placed. In other words, in the present embodiment, in the rotation axis direction of the rotary (Y direction), the range in which a third rack (rack portion 83y) is placed at least partially overlaps the range in which a fourth rack (rack portion 83c) is placed. Therefore, as compared with the arrangement in which the rack portion 83y and the guided portion 82y do not overlap the rack portion 83c and the guided portion 82c, the rack portions 83y and 83c and the guided portions 82y and 82c can be disposed in a space-saving manner in the Y direction.

Here, the meshing position between the rack portion 83 and the pinion 94 will be described with reference to FIG. 10. The upper half of FIG. 10 shows the meshing position between the rack portion 83k and the pinion 94k. The lower half of FIG. 10 shows the meshing position between the rack portion 83y and the pinion 94y.

In the direction of the rotation axis 90C (Y direction) of the rotary body 90, in the range Y1 in the drawing, driving force transmitted by the transmission device (described later) from the motor M2 (FIG. 2) serving as the drive source is transmitted to the pinions 94y to 94k. In the range Y2 in the drawing in the Y direction, the pinion 94k is drivably in mesh with the rack portion 83k. In the range Y3 in the drawing in the Y direction, the pinion 94y is drivably in mesh with the rack portion 83y. The rack portion 83m, as in the case of the rack portion 83k, is drivably in mesh with the pinion 94m (FIG. 8) in the range Y2. The rack portion 83c, as in the case of the rack portion 83y, is drivably in mesh with the pinion 94c (FIG. 8) in the range Y3.

Here, the range Y2 and the range Y3 lie at different positions in the Y direction (lie with an offset in the Y direction). The range Y1 is located at a different position in the Y direction from any one of the range Y2 and the range Y3. In other words, the range Y1 lies with an offset in the Y direction from the range Y2 and the range Y3.

Furthermore, in a state in which the toner cartridges 70y and 70c are at the mounted position, the range in which the rack portion 83y is placed at least partially overlaps the range in which the rack portion 83c is placed in the moving direction of the rack portion 83y (the moving direction Dy of the tray 80y). In the present embodiment, since the moving directions Dy and Dc of the trays 80y and 80c are substantially the same direction (parallel), the range in which the rack portion 83y is placed at least partially overlaps the range in which the rack portion 83c is placed also in the moving direction Dc of the tray 80c. Therefore, in a state in which the toner cartridges 70y and 70c are at the mounted position, the tooth surface of the rack portion 83y faces the tooth surface of the rack portion 83c in a direction orthogonal to the moving directions Dy and Dc of the rack portions 83y and 83c (the right and left direction in FIG. 8).

Furthermore, in a state in which the toner cartridges 70m and 70k are at the mounted position, the range in which the rack portion 83m is placed at least partially overlaps the range in which the rack portion 83k is placed in the moving direction of the rack portion 83m (the moving direction Dm of the tray 80m). In the present embodiment, since the moving directions Dm and Dk of the trays 80m and 80k are substantially the same direction (parallel), the range in which the rack portion 83m is placed at least partially overlaps the range in which the rack portion 83k is placed also in the moving direction Dk of the tray 80k. Therefore, in a state in which the toner cartridges 70m and 70k are at the mounted position, the tooth surface of the rack portion 83m faces the tooth surface of the rack portion 83k in a direction orthogonal to the moving directions Dm and Dk of the rack portions 83m and 83k (the up and down direction in FIG. 8).

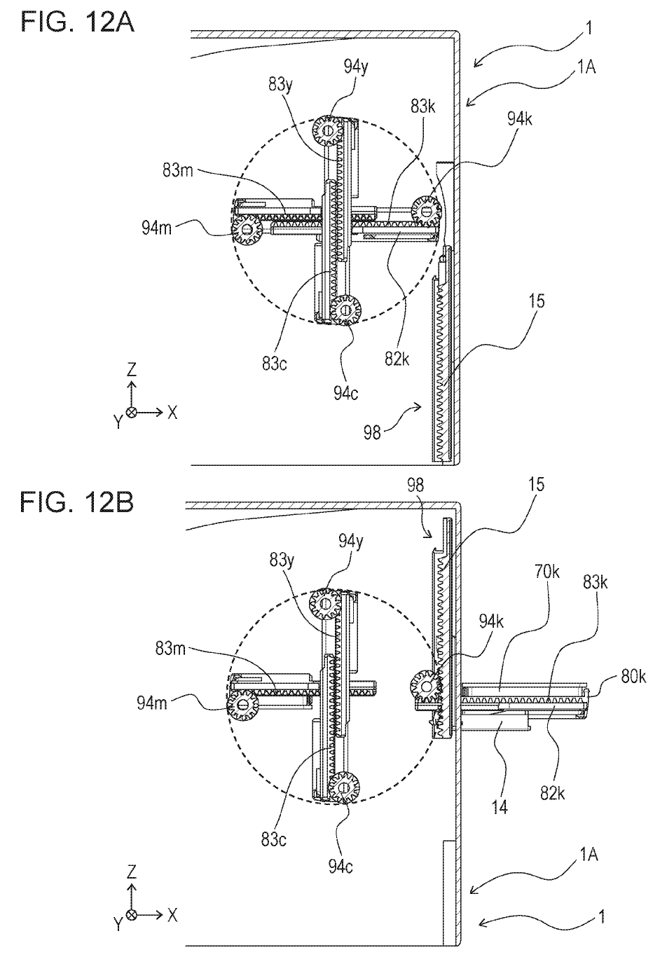

As shown in FIG. 12A (described later), when viewed in the direction of the rotation axis 90C (Y direction), the rack portion 83y overlaps the rack portion 83m and the rack portion 83k. When viewed in the direction of the rotation axis 90C (Y direction), the rack portion 83m overlaps the rack portion 83y and the rack portion 83c. When viewed in the direction of the rotation axis 90C (Y direction), the rack portion 83c overlaps the rack portion 83m and the rack portion 83k. When viewed in the direction of the rotation axis 90C (Y direction), the rack portion 83k overlaps the rack portion 83y and the rack portion 83c. In other words, in the rotation axis direction of the rotary (Y direction), the range in which the first rack (rack portion 83k) is placed does not overlap the range in which the second rack (rack portion 83y) is placed. When viewed in the rotation axis direction of the rotary (Y direction), the first rack (rack portion 83k) overlaps the second rack (rack portion 83y) in a state in which the first toner cartridge 70k is at the first mounted position and the second toner cartridge 70y is at the second mounted position.

In this way, since the positions at which the rack portions 83k and 83m are placed in the Y direction differ from the positions at which the rack portions 83y and 83c are placed in the Y direction, the rack portions 83y and 83c and the rack portions 83m and 83k can be disposed so as to overlap each other when viewed in the Y direction.

Thus, a space-saving four tray arrangement within the rotary body 90 is provided, so it is possible to reduce the size of the rotary body 90 in the radial direction of the rotary body 90. In other words, when the rack portions 83 are disposed so as not to overlap each other when viewed in the Y direction while the moving distance of each of the trays 80y to 80k is equivalent to that of the present embodiment, the area needed to dispose four rack portions increases when viewed in the Y direction. As compared with this configuration, the area of arrangement of the rack portions 83 reduces when viewed in the Y direction since the plurality of rack portions 83 are disposed so as to be shifted in position in the Y direction and the rack portions 83 are caused to overlap each other when viewed in the Y direction.

In the present embodiment, the four rack portions 83y to 83k are paired two by two, and the two pairs are disposed so as to be shifted in the Y direction. In other words, in the rotation axis direction (Y direction) of the rotary, the range in which the first rack is placed and the range in which the second rack is placed overlap, and the range in which the third rack is placed and the range in which the fourth rack is placed overlap. In the Y direction, the range in which the first rack and the second rack are placed and the range in which the third rack and the fourth rack are placed are disposed so as not to overlap each other. As a result, it is possible to reduce the size of the rotary body 90 in the Y direction as compared with when each of the four rack portions 83y to 83k is shifted in the Y direction.

### Tray Movement Configuration

The configuration related to the movement of the trays 80y to 80k disposed in the rotary body 90 will be described with reference to FIGS. 11A, 11B, 12A, and FIG. 12B. FIGS. 11A and 11B are perspective views of the configuration related to the movement of the tray 80k. FIGS. 12A and 12B are cross-sectional views of the configuration related to the movement of the tray 80k.

In the present embodiment, the trays 80y to 80k are driven by the driving force of the motor M2, transmitted to the pinions 94y to 94k by drive racks 15L and 15R serving as the transmission device. Here, the configuration for moving the tray 80k relative to the rotary body 90 will be described, and the configuration for moving the trays 80y to 80c relative to the rotary body 90 is substantially the same as the configuration for moving the tray 80k, so the description thereof is omitted.

FIG. 11A shows a state in which the tray 80k is placed inside the rotary body 90 (that is, a state in which the toner cartridge 70k is mounted on the developing unit 50k). In other words, FIG. 11A shows a state in which the tray 80k is at the storage position and corresponds to a state in which the toner cartridge 70k is at the mounted position relative to the developing frame 53k (FIG. 4A). FIG. 11B shows a state in which the tray 80k has been slid to the outside of the rotary body 90. In other words, FIG. 11B shows a state in which the tray 80k is at the eject position and corresponds to a state in which the toner cartridge 70k is at the retreat position relative to the developing frame 53k (FIG. 4B).

The apparatus main body 1A of the present embodiment includes the drive racks 15L and 15R as drive gears that drive the pinions 94. Each of the drive racks 15 is driven by the motor M2 via a drive transmission mechanism (not shown).

As described earlier, two rack portions 83k are respectively provided at both ends of the tray 80k in the Y direction. The two pinions 94k and the two drive racks 15L and 15R are respectively disposed at the positions corresponding to the rack portions 83k at both ends. In other words, the apparatus main body 1A of the present embodiment includes the drive racks 15L and 15R as a first drive gear and a second drive gear. The drive rack 15L is an example of the first drive gear, and the drive rack 15R is an example of the second drive gear.

However, these designations are used for the sake of convenience of description and may be interchanged as needed. When there is no need to distinguish between the drive racks 15L and 15R, the drive racks 15L and 15R are referred to as "drive racks 15".

The rack portions 83 of the present embodiment are configured as a rack pair, and the pinions 94 of the present embodiment are configured as a pinion pair. In the present embodiment, the rack pair and the pinion pair are disposed at one end and the other end of the support member (tray 80) in the Y direction; however, the rack pair and the pinion pair may be disposed at other positions. The rack portions 83k and pinions 94k of the moving device 85k corresponding to the tray 80k may be regarded as examples of a first rack pair and a first pinion pair.

Any one set of the rack portions 83y to 83c and the pinions 94y to 94c of the moving devices 85y to 85c corresponding to the other trays 80y to 80c may be regarded as examples of a second rack pair and a second pinion pair.

One of the racks in the rack pair is in mesh with one of the pinions in the pinion pair, and the other of the racks in the rack pair is in mesh with the other of the pinions in the pinion pair. At least one of the pinions in the pinion pair is driven by the drive rack 15L serving as a first drive rack. In the present embodiment, both of the pinions in the pinion pair are driven at the same time by the drive racks 15L and 15R serving as the first drive rack and a second drive rack. Thus, the tray 80 is less likely to rotate, with the result that it is possible to stably move the toner cartridge 70.

The tray 80 may have a single rack portion 83 and may be configured to be moved by a single drive rack 15 through a single pinion 94.

The tray 80k is held so as to be slidable in a direction parallel to the guided portion 82k (that is, the moving direction Dk) relative to the rotary body 90. The drive rack 15 is held so as to be slidable in a direction that intersects the moving direction Dk of the tray 80k relative to the apparatus main body 1A. The drive rack 15 is configured to slide (reciprocate) in a first direction (vertically upward in the present embodiment) and in a second direction (vertically downward in the present embodiment) opposite to the first direction relative to the apparatus main body 1A. In other words, the moving direction of the drive rack 15 of the present embodiment is a direction that intersects (preferably, a direction orthogonal to) both the moving direction Dk of the tray 80k and the direction of the rotation axis 90C (Y direction) of the rotary body 90.

The tray moving operation for sliding the tray 80k between the storage position and the eject position will be described with reference to FIGS. 11A and 11B. The tray moving operation of the tray 80k is performed by the motor M2 (FIG. 2), the drive transmission mechanism (not shown), the drive racks 15, the pinions 94k, and the rack portions 83k.

Initially, a tray moving operation (tray ejection operation) when the toner cartridge 70k is detached from the rotary body 90 will be described. In a state before the tray ejection operation is started, the drive rack 15 is positioned below the position at which the drive rack 15 meshes with the pinion 94k (FIG. 11A). As described earlier, in the replacement operation of the toner cartridge 70k, the rotary body 90 takes the replacement posture of the toner cartridge 70k (FIG. 4B).

When the tray ejection operation is started, the drive rack 15 is slid upward relative to the apparatus main body 1A by the driving force of the motor M2. During the process in which the drive rack 15 moves, the drive rack 15 engages with the pinion 94k, and the pinion 94k is rotationally driven.

As shown in FIG. 11B, when the pinion 94k is rotationally driven in the direction of the arrow in the drawing, the driving force is input to the rack portion 83k that is in mesh with the pinion 94k. As a result, the tray 80k is pushed out to the outside of the machine and moves from the storage position to the eject position relative to the rotary body 90. The moving direction of the tray 80k at this time is guided in the predetermined moving direction Dk by the engagement of the guided portion 82k with the guide portion 97k of the rotary body 90 (FIG. 7A). As a result of the tray 80k moving from the storage position to the eject position, the toner cartridge 70k is moved from the mounted position to the retreat position relative to the developing unit 50k.

In a state in which the tray 80k is at the eject position and the toner cartridge 70k is at the retreat position, a user is able to attach the toner cartridge 70k to or detach the toner cartridge 70k from the tray 80k.

A tray moving operation (tray insertion operation) when the toner cartridge 70 is attached to the rotary body 90 is performed in the reverse process of the tray ejection operation. For example, when the user operates a predetermined operation unit, the tray insertion operation is started. When the tray insertion operation is started, the drive rack 15 is slid downward relative to the apparatus main body 1A by the driving force of the motor M2. Here, the rotation direction of the motor M2 in the tray insertion operation is opposite to that in the tray ejection operation.

When the pinion 94k is rotationally driven in a direction opposite to the arrow in FIG. 11B, the driving force is input to the rack portion 83k that is in mesh with the pinion 94k. As a result, the tray 80k is pulled into the machine and moves from the eject position to the storage position relative to the rotary body 90.

The moving direction of the tray 80k is guided in the moving direction Dk (the direction opposite to the arrow in FIG. 11B) by the engagement of the guided portion 82k with the guide portion 97k (FIG. 7A) of the rotary body 90. As a result of the tray 80k moving from the eject position to the storage position, the toner cartridge 70k is moved from the retreat position to the mounted position relative to the developing unit 50k.

The movement of the black tray 80k and the black toner cartridge 70k has been described, and the movement of the other trays 80y to 80c and the other toner cartridges 70y to 70c is also performed by similar mechanisms. In other words, in the replacement posture of each toner cartridge, the drive rack 15 transmits driving force to a corresponding one of the pinions 94y to 94c.

The drive device 98 for driving the moving devices 85 provided in the rotary body 90 is formed of the motor M2 provided in the apparatus main body 1A and the transmission device including the drive racks 15 (15L and 15R) and the drive transmission mechanism.

As described earlier, in the present embodiment, the plurality of moving devices 85k to 85y corresponding to the plurality of toner cartridges 70k to 70y are disposed in the rotary body 90. The drive device 98 of the apparatus main body 1A is a common drive device that drives the plurality of moving devices 85k to 85y (a plurality of driven devices) of the rotary body 90.

In the present embodiment, the target to be driven by the drive device 98 switches with the rotation of the rotary body 90. In other words, the drive device of the present embodiment includes the drive rack 15 as a transmission member for transmitting the driving force of the drive source. The drive device is capable of taking a state in which the transmission member drivably engages with the first driven unit (pinion 94k) and a state in which the transmission member drivably engages with the second driven unit (pinion 94m). The drive device is capable of taking a state in which the transmission member is disengaged from the first driven unit and the second driven unit.

As described above, the pinions 94y to 94k are held in the rotary body 90. Therefore, when the rotary body 90 rotates, the meshing of the pinions 94y to 94k with the drive rack 15 is preferably released.

FIG. 12A shows a state in which the tray 80k is placed inside the rotary body 90 (a state at the storage position). FIG. 12B shows a state in which the tray 80k has moved to the outside of the rotary body 90 (a state of having moved to the eject position).

As shown in FIG. 12A, when the tray 80k is placed inside the rotary body 90, the drive rack 15 is positioned at the bottom in the apparatus main body 1A. At this time, the drive rack 15 is retracted from the pinion 94k. Therefore, the rotary body 90 is allowed to be rotated without any interference with the drive rack 15. More specifically, the drive rack 15 can retract to the outside of the rotation trajectory of the rotary body 90, indicated by the dashed line in FIGS. 12A and 12B.

As described above, when the motor M2 is rotationally driven in the forward and reverse directions, the tray 80 attached to the rotary body 90 can be moved from the storage position to the eject position and from the eject position to the storage position relative to the rotary body 90. In other words, the drive device of the present embodiment is capable of not only driving each moving device of the rotary such that the toner cartridge moves from the mounted position to the retreat position but also driving each moving device such that the toner cartridge moves from the retreat position to the mounted position.

Here, as described earlier, in the present embodiment, the amount of movement of the tray 80 during toner cartridge replacement is changed according to the size of the toner cartridge 70. Specifically, as shown in FIGS. 7A and 7B, the moving distance L1 when the black tray 80k moves from the storage position to the eject position is greater than the moving distance L2 when the other trays 80y to 80c move from the storage position to the eject position.

Therefore, in the present embodiment, when the toner cartridges 70y to 70k are moved from the mounted position to the retreat position, the value obtained by dividing the speed of the rack portion 83k by the speed of the drive rack 15 is greater than the value obtained by dividing the speed of each of the rack portions 83y to 83c by the speed of the drive rack 15.

For example, as shown in FIG. 10, the pinion 94y is a stepped gear, the pitch radius of a small-diameter gear 942 that meshes with the rack portion 83y is smaller than the pitch radius of a large-diameter gear 941 that meshes with the drive rack 15. The pinions 94m and 94c are also similar stepped gears. On the other hand, the pinion 94k is made such that a portion that meshes with the drive rack 15 and a portion that meshes with the rack portion 83k have the same pitch radius. At this time, the pitch radius of the pinion 94k can be set to the same radius as the pitch radius of the large-diameter gears 941 of the pinions 94y to 94c. With this configuration, even when the moving distance of the drive rack 15 is the same, the moving distance of the rack portion 83k can be made greater than the moving distances of the other rack portions 83y to 83c. In other words, the moving distance L1 when the black tray 80k moves from the storage position to the eject position can be made greater than the moving distance L2 when the other trays 80y to 80c move from the storage position to the eject position.

When the pinions 94y to 94c are stepped gears, the moving distance L1 of the tray 80k can be made greater than the moving distance L2 of the other trays 80y to 80c although the pinions 94y to 94k receive driving force from the same drive rack 15.

Instead of (or in combination with) the configuration in which the pinions 94y to 94c are used as stepped gears, the pinion 94k may also be used as a stepped gear. In this case, it is sufficient that a portion of the pinion 94k, which meshes with the drive rack 15, is formed as a small-diameter gear and a portion of the pinion 94k, which meshes with the rack portion 83k, is formed as a large-diameter gear greater in pitch radius than the small-diameter gear. The stepped gear is an example of a speed reduction mechanism and may be replaced with a known speed reduction mechanism that reduces the amount of movement of an output-side (tray 80-side) member more than the amount of movement of the input-side (drive source-side) member.

The amount of movement of the drive rack 15 when the toner cartridge 70k is moved from the mounted position to the retreat position may be greater than the amount of movement of the drive rack 15 when the toner cartridges 70y to 70c are moved from the mounted position to the retreat position.

Incidentally, as the distance by which the toner cartridge 70 moves from the mounted position to the retreat position shortens, the moving time period of the toner cartridge 70 can be shortened, so a period of time for which the user waits for movement of the toner cartridge 70 can be shortened. With the configuration in which the amount of movement of the drive rack 15 for the toner cartridge 70k is greater than the amount of movement of the drive rack 15 for the toner cartridges 70y to 70c as described above, a period of time for which the user waits for movement of the toner cartridges 70y to 70c can be shortened.

With the configuration described above, the moving distance L1 can be made greater than the moving distance L2. These configurations can also be used in combination.

The configuration in which the driven unit includes the pinion 94 that meshes with both the drive rack 15 and the rack portion 83 has been described. Alternatively, the driven unit may include a gear that meshes with the drive rack 15 and a gear that meshes with the rack portion 83.

The configuration of the moving device 85 for moving the tray 80 is not limited to a so-called rack and pinion mechanism. For example, the member corresponding to the pinion 94 may be replaced with a roller that rotates under the drive of the motor M2, and the tray 80 is moved by the friction between the roller and the tray 80.

When a roller that rotates under the drive of the motor M2 is used, the roller may be brought into contact with the toner cartridge 70. In this case, the toner cartridges 70y to 70kmay be configured to be directly attached to and detached from the rotary body 90 without intervention of the trays 80y to 80k. In this case, the moving device 85 is formed of rollers. Furthermore, the rotary assembly 90A may be regarded as including the rotary body 90 and the toner cartridges 70y to 70k.

### Guide for Toner to Discharge Opening

As described above, toner stored in the toner storage chamber 71a is discharged through the discharge opening 71b, and the toner discharged through the discharge opening 71b is put into the developing-side storage chamber 53a through the receiving opening 53b.

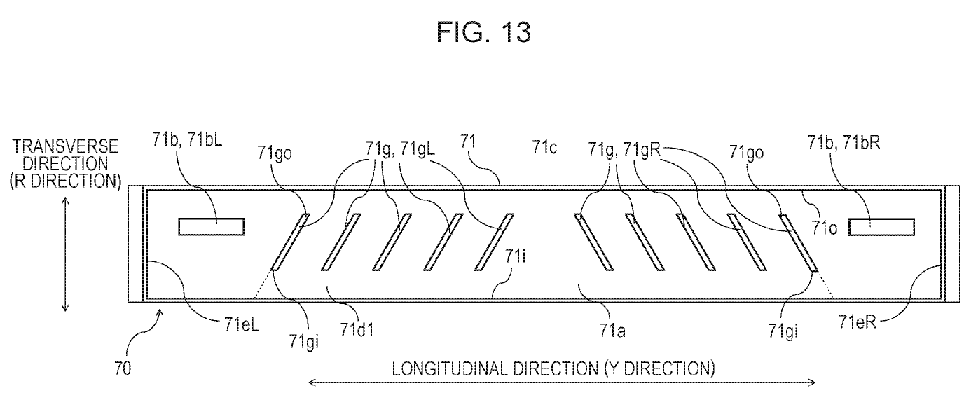

In the following description, it is assumed that the toner cartridge 70 is attached to the rotary body 90. A configuration for efficiently discharging, through the discharge opening 71b, toner stored in the toner storage chamber 71a will be described with reference to FIGS. 13, 14, 29A, and FIG. 29B.

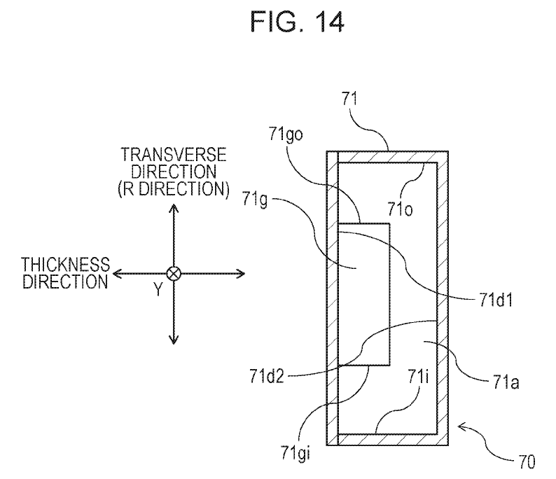

FIG. 13 is a view that shows the internal structure of the toner cartridge 70. FIG. 14 is a cross-sectional view that shows the internal structure of the toner cartridge 70 and, specifically, a cross-sectional view of the toner cartridge 70, taken in a direction orthogonal to the rotation axis 90C, when viewed in the Y direction.

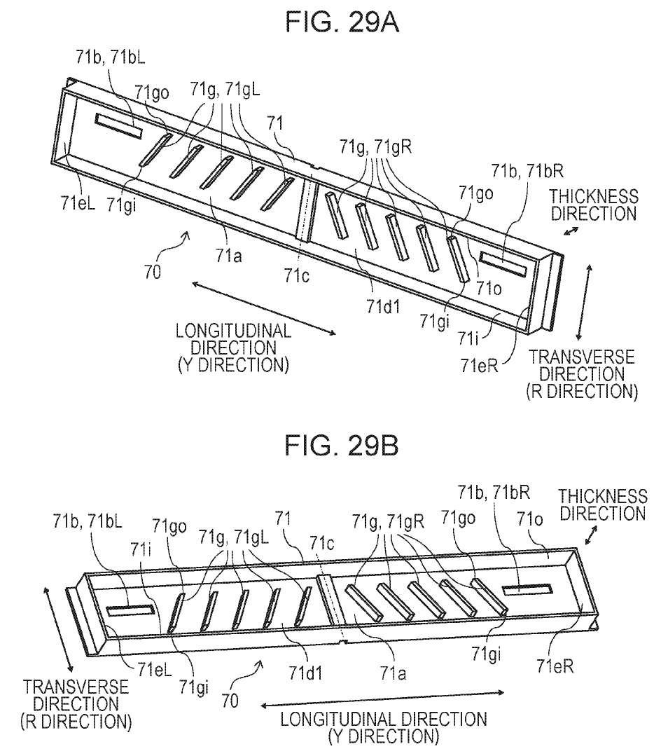

FIGS. 29A and 29B are perspective views that show the internal structure of the toner cartridge 70.

Here, assume that the toner cartridge 70 is projected in a first projection direction onto a first imaginary plane orthogonal to the first projection direction. At this time, the first projection direction that minimizes the projected area on the first imaginary plane can be referred to as the longitudinal direction of the toner cartridge 70. As described above, in a state in which the toner cartridge 70 is mounted on the rotary body 90, the longitudinal direction of the toner cartridge 70 is parallel to the direction (Y direction) of the rotation axis 90C of the rotary body 90.

Furthermore, assume that a direction orthogonal to the first projection direction is a second projection direction and the toner cartridge 70 is projected in the second projection direction onto a second imaginary plane orthogonal to the second projection direction. At this time, the second projection direction that minimizes the projected area on the second imaginary plane can be referred to as the transverse direction of the toner cartridge 70. In other words, the transverse direction of the toner cartridge 70 is a direction orthogonal to the longitudinal direction of the toner cartridge 70. Furthermore, a direction orthogonal to the longitudinal direction and the transverse direction of the toner cartridge 70 is referred to as the thickness direction of the toner cartridge 70.

In the present embodiment, the longitudinal direction, transverse direction, and thickness direction of the toner frame 71 can be defined in the same manner as the longitudinal direction, transverse direction, and thickness direction of the toner cartridge 70. In other words, the longitudinal direction, transverse direction, and thickness direction of the toner frame 71 are the same as the longitudinal direction, transverse direction, and thickness direction of the toner cartridge 70. Therefore, the length of each of the toner cartridge 70 and the toner frame 71 in the longitudinal direction is greater than the length in the transverse direction and the length in the thickness direction. The length in the transverse direction of each of the toner cartridge 70 and the toner frame 71 is greater than the length in the thickness direction.

In the following description, the longitudinal direction, transverse direction, and thickness direction of the toner frame 71 and the longitudinal direction, transverse direction, and thickness direction of the toner cartridge 70 are not distinguished from each other and are simply referred to as the longitudinal direction, the transverse direction, and the thickness direction.

As shown in FIG. 13, the toner frame 71 has the toner storage chamber 71a, and a left side surface 71eL and a right side surface 71eR facing each other. The left side surface 71eL and the right side surface 71eR are surfaces that extend in a direction intersecting (preferably, a direction orthogonal to) the longitudinal direction, and face each other in the longitudinal direction. A normal direction to the left side surface 71eL and a normal direction to the right side surface 71eR may be regarded as including a component in the longitudinal direction. In the longitudinal direction, the left side surface 71eL is located on one end side relative to the center 71c of the toner frame 71, and the right side surface 71eR is located on the other end side relative to the center 71c of the toner frame 71. In the longitudinal direction, the left side surface 71eL is located at one end of the toner storage chamber 71a, while the right side surface 71eR is located at the other end of the toner storage chamber 71a.

The left side surface 71eL does not need to be a single surface. In other words, the toner frame 71 may have a plurality of surfaces having the features of the above-described left side surface 71eL. In other words, the toner frame 71 may have a plurality of surfaces, and each of the plurality of surfaces may be the left side surface 71eL. In this case, the plurality of surfaces do not need to be parallel to each other, and may have different positions in the longitudinal direction.

Similarly, the right side surface 71eR does not need to be a single surface. In other words, the toner frame 71 may have a plurality of surfaces having the features of the above-described right side surface 71eR. In other words, the toner frame 71 may have a plurality of surfaces, and each of the plurality of surfaces may be the right side surface 71eR. In this case, the plurality of surfaces do not need to be parallel to each other, and may have different positions in the longitudinal direction.

As shown in FIGS. 13 and 14, the toner frame 71 has the toner storage chamber 71a, and an outer surface 71o and an inner surface 71i facing each other. The outer surface 71o and the inner surface 71i are surfaces that extend in a direction intersecting (preferably, a direction orthogonal to) the transverse direction and that face each other in the transverse direction. In other words, the outer surface 71o and the inner surface 71i may be regarded as surfaces extending along the thickness direction and the longitudinal direction. A normal direction to the outer surface 71o and a normal direction to the inner surface 71i may be regarded as including a component in the transverse direction. In the radial direction of the rotary body 90, the inner surface 71i is closer to the rotation axis 90c than the outer surface 71o. In the transverse direction, the outer surface 71o is located at one end of the toner storage chamber 71a, and the inner surface 71i is located at the other end of the toner storage chamber 71a.

The outer surface 71o does not need to be a single surface. In other words, the toner frame 71 may have a plurality of surfaces having the features of the above-described outer surface 71o. In other words, the toner frame 71 may have a plurality of surfaces, and each of the plurality of surfaces may be the outer surface 71o. In this case, the plurality of surfaces do not need to be parallel to each other, and may have different positions in the transverse direction.

Similarly, the inner surface 71i does not need to be a single surface. In other words, the toner frame 71 may have a plurality of surfaces having the features of the above-described inner surface 71i. In other words, the toner frame 71 may have a plurality of surfaces, and each of the plurality of surfaces may be the inner surface 71i. In this case, the plurality of surfaces do not need to be parallel to each other, and may have different positions in the transverse direction.

As shown in FIGS. 13 and 14, the toner frame 71 has the toner storage chamber 71a, and a first receiving surface 71d1 and a second receiving surface 71d2 facing each other. The first receiving surface 71d1 and the second receiving surface 71d2 are surfaces that extend in a direction intersecting (preferably, a direction orthogonal to) the thickness direction and that face each other in the thickness direction. In other words, the first receiving surface 71d1 and the second receiving surface 71d2 may be regarded as surfaces extending along the transverse direction and the longitudinal direction. A normal direction to the first receiving surface 71d1 and a normal direction to the second receiving surface 71d2 may be regarded as including a component in the thickness direction. In the thickness direction, the first receiving surface 71d1 is located at one end of the toner storage chamber 71a, and the second receiving surface 71d2 is located at the other end of the toner storage chamber 71a.

The first receiving surface 71d1 does not need to be a single surface. In other words, the toner frame 71 may have a plurality of surfaces having the features of the above-described first receiving surface 71d1. In other words, the toner frame 71 may have a plurality of surfaces, and each of the plurality of surfaces may be the first receiving surface 71d1. In this case, the plurality of surfaces do not need to be parallel to each other, and may have different positions in the thickness direction.

Similarly, the second receiving surface 71d2 does not need to be a single surface. In other words, the toner frame 71 may have a plurality of surfaces having the features of the above-described second receiving surface 71d2. In other words, the toner frame 71 may have a plurality of surfaces, and each of the plurality of surfaces may be the second receiving surface 71d2. In this case, the plurality of surfaces do not need to be parallel to each other, and may have different positions in the thickness direction.

As shown in FIG. 13, the toner frame 71 of the present embodiment has a plurality of discharge openings including a discharge opening (first opening) 71bL and a discharge opening (second opening) 71bR. Each of the discharge openings 71bL and 71bR functions as the discharge opening 71b communicating with the toner storage chamber 71a. In the longitudinal direction, the discharge opening 71bL is located on one end side relative to the center 71c of the toner frame 71, and is located between the center 71c and the left side surface 71eL. In the longitudinal direction, the discharge opening 71bR is located on the other end side relative to the center 71c of the toner frame 71, and is located between the center 71c and the right side surface 71eR. In the present embodiment, in the longitudinal direction, the discharge opening 71bL is closer to the left side surface 71eL than to the center 71c, and the discharge opening 71bR is closer to the right side surface 71eR than to the center 71c.

In the present embodiment, the discharge opening 71bL is disposed such that, when the discharge opening 71bL is projected in the thickness direction onto a plane perpendicular to the thickness direction, the projected area is maximum. The discharge opening 71bR is disposed such that, when the discharge opening 71bR is projected in the thickness direction onto a plane perpendicular to the thickness direction, the projected area is maximum.

In the present embodiment, the discharge openings 71bL and 71bR are provided at the first receiving surface 71d1 of the toner frame 71. Therefore, the discharge openings 71bL and 71bR face the second receiving surface 71d2 of the toner frame 71. In the present embodiment, the first receiving surface 71d1 having the discharge opening 71bL and the first receiving surface 71d1 having the discharge opening 71bR are continuous. However, the first receiving surface 71d1 having the discharge opening 71bL and the first receiving surface 71d1 having the discharge opening 71bR may be discontinuous.

The toner frame 71 has at least one guide portion 71g for guiding toner stored in the toner storage chamber 71a. The toner frame 71 of the present embodiment includes a plurality of the guide portions 71g. Each of the guide portions 71g is configured to guide, toward the discharge opening 71b in the Y direction, the toner moving under the weight of the toner in a direction intersecting the Y direction.

In the present embodiment, the spacing between the plurality of guide portions 71g is constant, and the inclination angle of each of the plurality of guide portions 71g is the same. However, the spacing between the plurality of guide portions 71g does not need to be constant. The inclination angles of the plurality of guide portions 71g may be different from each other.

In the present embodiment, the toner frame 71 includes at least one left-side guide 71gL and at least one right-side guide 71gR. In the present embodiment, the toner frame 71 includes a plurality of left-side guides 71gL and a plurality of right-side guides 71gR. The left-side guides 71gL guide the toner toward the discharge opening 71bL in the Y direction, and the right-side guides 71gR guide the toner toward the discharge opening 71bR in the Y direction. In other words, the toner frame 71 includes a plurality of toner guides, and the plurality of toner guides includes the left-side guides 71gL and the right-side guides 71gR.

In the longitudinal direction, the left-side guides 71gL are disposed between the center 71c of the toner frame 71 and the discharge opening 71bL, and the right-side guides 71gR are disposed between the center 71c of the toner frame 71 and the discharge opening 71bR. The left-side guides 71gL and the discharge opening 71bL and the right-side guides 71gR and the discharge opening 71bR have a symmetric shape in the longitudinal direction; however, the left-side guides 71gL and the discharge opening 71bL and the right-side guides 71gR and the discharge opening 71bR do not need to have a perfectly symmetric shape. The number of the left-side guides 71gL may be different from the number of the right-side guides 71gR.

The left-side guide 71gL and the right-side guide 71gR guide toner in different directions; however, the left-side guide 71gL and the right-side guide 71gR generally have substantially a common basic configuration and function. Therefore, in the following description, the left-side guides 71gL and the right-side guides 71gR are referred to as the guide portion 71g, the discharge opening 71bL and the discharge opening 71bR are referred to as the discharge opening 71b, and they will be collectively described.

As shown in FIG. 14, the guide portion 71g is closer to the first receiving surface 71d1 than to the second receiving surface 71d2. In the present embodiment, the guide portion 71g is disposed on the first receiving surface 71d1. In other words, the base of the guide portion 71g is connected to the first receiving surface 71d1. The first receiving surface 71d1 having the discharge opening 71bL, the first receiving surface 71d1 having the discharge opening 71bR, and the first receiving surface 71d1 connected with the guide portion 71g may be discontinuous. For example, the first receiving surface 71d1 having the discharge opening 71bL, the first receiving surface 71d1 having the discharge opening 71bR, and the first receiving surface 71d1 to which the guide portion 71g is connected do not need to be parallel to each other and may have different positions in the thickness direction. On the other hand, there is a gap formed between the guide portion 71g and the second receiving surface 71d2.

When the toner cartridge 70 is attached to or detached from the developing device 50, the first receiving surface 71d1 having the discharge opening 71bL, the first receiving surface 71d1 having the discharge opening 71bR, and the first receiving surface 71d1 to which the guide portion 71g is connected are all positioned on the upper end side of the toner storage chamber 71a. The tip of the guide portion 71g is positioned below the discharge opening 71bL and the discharge opening 71bR. As a result, when the toner cartridge 70 takes the posture for being attached to or detached from the developing device 50, excessive concentration of toner below the discharge opening 71bR and the discharge opening 71bL is suppressed.

As shown in FIGS. 13 and 14, the guide portion 71g has an outer end 71go and an inner end 71gi. In the radial direction of the rotary body 90, the inner end 71gi is closer to the rotation axis 90c than the outer end 71go. In the longitudinal direction, the inner end 71gi is closer to the discharge opening 71b than the outer end 71go. When viewed in a direction perpendicular to the first receiving surface 71d1, the angle formed between a straight line passing through the inner end 71gi and the outer end 71go and the longitudinal direction is preferably larger than the angle of repose of the toner.

In the present embodiment, in the transverse direction, the distance between the outer end 71go and the inner end 71gi is less than the distance between the outer surface 71o and the inner surface 71i. In the transverse direction, the outer surface 71o faces the outer end 71go, and a gap is formed between the outer surface 71o and the outer end 71go. The inner surface 71i faces the inner end 71gi, and a gap is formed between the inner surface 71i and the inner end 71gi.

The guide portion 71g guides, toward the discharge opening 71b in the longitudinal direction, the toner moving from the outer end 71go toward the inner end 71gi in the transverse direction.

When the first receiving surface (first surface) 71d1 receives the weight of toner and is inclined relative to the horizontal direction and the inclination angle of the first receiving surface 71d1 relative to the horizontal direction exceeds a predetermined angle, the toner moves on the first receiving surface 71d1 along the first receiving surface 71d1. At this time, the guide portion 71g guides, toward the discharge opening 71b in the longitudinal direction, the toner moving along the first receiving surface 71d1.

More specifically, assume that, in a state in which the first receiving surface 71d1 is positioned below the second receiving surface 71d2, the first receiving surface 71d1 is inclined relative to the horizontal direction such that the outer end of the first receiving surface 71d1 in the radial direction of the rotary body 90 is higher in level than the inner end of the first receiving surface 71d1. When the inclination angle of the first receiving surface 71d1 relative to the horizontal direction exceeds a predetermined angle, toner moves along the first receiving surface 71d1 from the outer end of the first receiving surface 71d1 toward the inner end of the first receiving surface 71d1 in a direction that intersects the rotation axis 90c of the rotary body 90.

When the toner moving on the first receiving surface 71d1 contacts the surface of the guide portion 71g facing the discharge opening 71b in the longitudinal direction, the toner is guided by the guide portion 71g toward the discharge opening 71b in the longitudinal direction.

On the other hand, when the second receiving surface (second surface) 71d2 receives the weight of the toner and is inclined relative to the horizontal direction and the inclination angle of the second receiving surface 71d2 relative to the horizontal direction exceeds a predetermined angle, the toner moves on the second receiving surface 71d2 along the second receiving surface 71d2. At this time, the toner moves from one of the outer end 71go and the inner end 71gi toward the other of the outer end 71go and the inner end 71gi in the radial direction of the rotary body 90 through a gap between the guide portion 71g and the second receiving surface 71d2. The toner moving through the gap between the guide portion 71g and the second receiving surface 71d2 can move without being guided by the guide portion 71g.

As shown in FIG. 13, in the transverse direction, the discharge openings 71b (discharge openings 71bL and 71bR) are disposed between the outer end 71go and the inner end 71gi. Furthermore, in the transverse direction, the discharge openings 71b (discharge openings 71bL and 71bR) are closer to the outer surface 71o than to the inner surface 71i. However, the arrangement of the discharge openings 71b (discharge openings 71bL and 71bR) is not limited thereto. In the transverse direction, the discharge openings 71b (discharge openings 71bL and 71bR) may be closer to the inner surface 71i than to the outer surface 71o.

In the present embodiment, the toner can move in the longitudinal direction through the gap formed between the outer surface 71o and the outer end 71go, and the gap formed between the inner surface 71i and the inner end 71gi. The toner can also move in the longitudinal direction through the gap between the guide portion 71g and the second receiving surface 71d2. Therefore, the guide portion 71g may be disposed such that at least one of the gap formed between the outer surface 71o and the outer end 71go and the gap formed between the inner surface 71i and the inner end 71gi is eliminated. In other words, the guide portion 71g may be connected to at least one of the outer surface 71o and the inner surface 71i.

As described later, with the rotation of the rotary assembly 90A, the toner moves along the first receiving surface 71d1 and the second receiving surface 71d2. The toner that has moved along the first receiving surface 71d1 and the second receiving surface 71d2 collides with the inner surface 71i and the outer surface 71o and spreads in the longitudinal direction.

### Rotation of Rotary Assembly and Movement of Toner

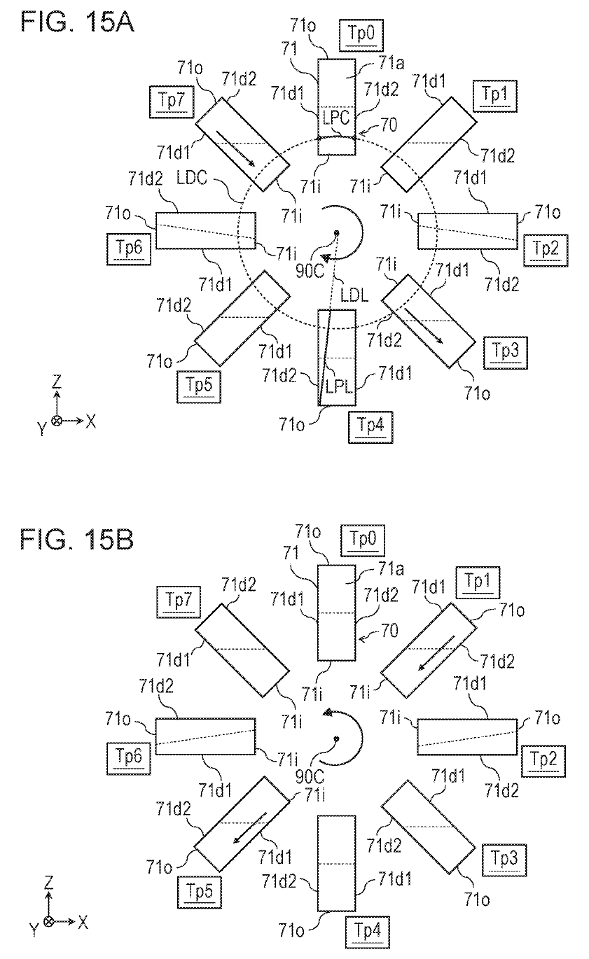

Movement of the toner accompanying rotation of the rotary assembly 90A will be described with reference to FIGS. 15A and 15B. FIGS. 15A and 15B are schematic views of the toner cartridge 70 revolving around the rotation axis 90C when viewed in the Y direction. In FIGS. 15A and 15B, the dashed line drawn inside the toner storage chamber 71a indicates a surface level of the toner (an upper surface of the toner) stored in the toner storage chamber 71a.

The toner cartridge 70 is attached to and detached from the rotary body 90 at position Tp2. When the toner cartridge 70 is at position Tp0, the first receiving surface 71d1 and the second receiving surface 71d2 are parallel to the Z direction, and the toner cartridge 70 is above the rotation axis 90c. When the toner cartridge 70 is at position Tp4, the first receiving surface 71d1 and the second receiving surface 71d2 are parallel to the Z direction, and the toner cartridge 70 is below the rotation axis 90c.

In FIG. 15A, the rotary assembly 90A rotates clockwise when viewed in the Y direction. When the toner cartridge 70 revolves once from position Tp0, the toner cartridge 70 moves in the order of position Tp0, position Tp1, position Tp2, position Tp3, position Tp4, position Tp5, position Tp6, and position Tp7, and returns to position Tp0.

At position Tp0, the toner is supported by the inner surface 71i, and the weight of the toner is borne by the inner surface 71i. When the toner cartridge 70 revolves clockwise from position Tp0, the weight of the toner is borne by the second receiving surface 71d2. The toner supported by the inner surface 71i at position Tp0 spontaneously collapses with revolution of the toner cartridge 70 and spreads over the second receiving surface 71d2.

When the toner cartridge 70 revolves from position Tp2 to position Tp4, the toner moves on the second receiving surface 71d2 from the inner surface 71i toward the outer surface 71o under the weight of the toner due to the gravity applied to the toner. At position Tp2, since the toner is present in a state biased toward the inner surface 71i, when the toner cartridge 70 moves from position Tp2 to position Tp4, a large amount of toner moves on the second receiving surface 71d2 from the inner surface 71i toward the outer surface 71o.

The toner that has moved on the second receiving surface 71d2 toward the outer surface 71o collides with the outer surface 71o and spreads in the longitudinal direction. The angle between the second receiving surface 71d2 and the outer surface 71o is preferably close to a right angle.

More specifically, when viewed in the longitudinal direction, the proportion of a portion of the outer surface 71o where the angle between the portion and the second receiving surface 71d2 is larger than or equal to 80 degrees and smaller than or equal to 100 degrees preferably exceeds 50% of the entire outer surface 71o, and, more preferably, exceeds 80%. As shown in FIGS. 29A and 29B, the outer surface 71o is a flat surface; however, the outer surface 71o may be a curved surface.

In the longitudinal direction, the length of a region where the angle between the outer surface 71o and the second receiving surface 71d2 satisfies the above condition preferably exceeds 50% of the length of the toner storage chamber 71a, and, more preferably, exceeds 80%.

At position Tp4, the toner is supported by the outer surface 71o, and the weight of the toner is borne by the outer surface 71o. When the toner cartridge 70 revolves clockwise from position Tp4, the weight of the toner is borne by the first receiving surface 71d1. The toner supported by the outer surface 71o at position Tp4 spontaneously collapses with revolution of the toner cartridge 70 and spreads over the first receiving surface 71d1.

When the toner cartridge 70 revolves from position Tp6 to position Tp0, the toner moves on the first receiving surface 71d1 from the outer surface 71o toward the inner surface 71i under the weight of the toner due to the gravity applied to the toner. At position Tp6, since the toner is present in a state biased toward the outer surface 71o, when the toner cartridge 70 moves from position Tp6 to position Tp0, a large amount of toner moves on the first receiving surface 71d1 from the outer surface 71o toward the inner surface 71i.

The toner that has moved on the first receiving surface 71d1 toward the inner surface 71i collides with the inner surface 71i and spreads in the longitudinal direction. The angle between the first receiving surface 71d1 and the inner surface 71i is preferably close to a right angle.

More specifically, when viewed in the longitudinal direction, the proportion of a portion of the inner surface 71i where the angle between the portion and the first receiving surface 71d1 is larger than or equal to 80 degrees and smaller than or equal to 100 degrees exceeds 50% of the entire inner surface 71i, and, more preferably, exceeds 80%. As shown in FIGS. 29A and 29B, the inner surface 71i is a flat surface; however, the inner surface 71i may be a curved surface.

In the longitudinal direction, the length of a region where the angle between the inner surface 71i and the first receiving surface 71d1 satisfies the above condition preferably exceeds 50% of the length of the toner storage chamber 71a, and, more preferably, exceeds 80%.

In the present embodiment, the rotary assembly 90A rotates clockwise when viewed in the Y direction (FIG. 15A). However, even when the rotary assembly 90A rotates counterclockwise when viewed in the Y direction, the toner inside the toner cartridge 70 moves with rotation of the rotary assembly 90A. In FIG. 15B, the rotary assembly 90A rotates counterclockwise when viewed in the Y direction. When the toner cartridge 70 revolves once from position Tp0, the toner cartridge 70 moves in the order of position Tp0, position Tp7, position Tp6, position Tp5, position Tp4, position Tp3, position Tp2, and position Tp1, and returns to position Tp0.

At position Tp0, the toner is supported by the inner surface 71i, and the weight of the toner is borne by the inner surface 71i. When the toner cartridge 70 revolves counterclockwise from position Tp0, the weight of the toner is borne by the first receiving surface 71d1. The toner supported by the inner surface 71i at position Tp0 spontaneously collapses with revolution of the toner cartridge 70 and spreads over the first receiving surface 71d1.

When the toner cartridge 70 revolves from position Tp6 to position Tp4, the toner moves on the first receiving surface 71d1 from the inner surface 71i toward the outer surface 71o under the weight of the toner due to the gravity applied to the toner. At position Tp6, since the toner is present in a state biased toward the inner surface 71i, when the toner cartridge 70 moves from position Tp6 to position Tp4, a large amount of toner moves on the first receiving surface 71d1 from the inner surface 71i toward the outer surface 71o.

The toner that has moved on the first receiving surface 71d1 toward the outer surface 71o collides with the outer surface 71o and spreads in the longitudinal direction. The angle between the first receiving surface 71d1 and the outer surface 71o is preferably close to a right angle.

More specifically, when viewed in the longitudinal direction, the proportion of a portion of the outer surface 71o where the angle between the portion and the first receiving surface 71d1 is larger than or equal to 80 degrees and smaller than or equal to 100 degrees exceeds 50% of the entire outer surface 71o, and, more preferably, exceeds 80%. As shown in FIGS. 29A and 29B, the outer surface 71o is a flat surface; however, the outer surface 71o may be a curved surface.

In the longitudinal direction, the length of a region where the angle between the outer surface 71o and the first receiving surface 71d1 satisfies the above condition preferably exceeds 50% of the length of the toner storage chamber 71a, and, more preferably, exceeds 80%.

At position Tp4, the toner is supported by the outer surface 71o, and the weight of the toner is borne by the outer surface 71o. When the toner cartridge 70 revolves counterclockwise from position Tp4, the weight of the toner is borne by the second receiving surface 71d2. The toner supported by the outer surface 71o at position Tp4 spontaneously collapses with revolution of the toner cartridge 70 and spreads over the second receiving surface 71d2.

When the toner cartridge 70 revolves from position Tp2 to position Tp0, the toner moves on the second receiving surface 71d2 from the outer surface 71o toward the inner surface 71i under the weight of the toner due to the gravity applied to the toner. At position Tp2, since the toner is present in a state biased toward the outer surface 71o, when the toner cartridge 70 moves from position Tp2 to position Tp0, a large amount of toner moves on the second receiving surface 71d2 from the outer surface 71o toward the inner surface 71i.

The toner that has moved on the second receiving surface 71d2 toward the inner surface 71i collides with the inner surface 71i and spreads in the longitudinal direction. The angle between the second receiving surface 71d2 and the inner surface 71i is preferably close to a right angle.

More specifically, when viewed in the longitudinal direction, the proportion of a portion of the inner surface 71i where the angle between the portion and the second receiving surface 71d2 is larger than or equal to 80 degrees and smaller than or equal to 100 degrees preferably exceeds 50% of the entire inner surface 71i, and, more preferably, exceeds 80%. As shown in FIGS. 29A and 29B, the inner surface 71i is a flat surface; however, the inner surface 71i may be a curved surface.

In the longitudinal direction, the length of a region where the angle between the inner surface 71i and the second receiving surface 71d2 satisfies the above condition preferably exceeds 50% of the length of the toner storage chamber 71a, and, more preferably, exceeds 80%.

In other words, with the rotation of the rotary assembly 90A, the toner moves on the first receiving surface 71d1. The angle between, of the inner surface 71i and the outer surface 71o, a surface located on a downstream side of the first receiving surface 71d1 in a moving direction of the toner and the first receiving surface 71d1 preferably satisfies the above-described relationship. In other words, the proportion of a portion where the angle between the surface and the first receiving surface 71d1 is larger than or equal to 80 degrees and smaller than or equal to 100 degrees preferably exceeds 50% of the entire surface. In the longitudinal direction, the length of the region that satisfies the condition preferably exceeds 50% of the length of the toner storage chamber 71a, and, more preferably, exceeds 80%.

With the rotation of the rotary assembly 90A, the toner moves on the second receiving surface 71d2. The angle between, of the inner surface 71i and the outer surface 71o, a surface located on a downstream side of the second receiving surface 71d2 in a moving direction of the toner and the second receiving surface 71d2 preferably satisfies the above-described relationship. In other words, the proportion of a portion where the angle between the surface and the second receiving surface 71d2 is larger than or equal to 80 degrees and smaller than or equal to 100 degrees preferably exceeds 50% of the entire surface. In the longitudinal direction, the length of the region that satisfies the condition preferably exceeds 50% of the length of the toner storage chamber 71a, and, more preferably, exceeds 80%.

In the present embodiment, both the inner surface 71i and the outer surface 71o satisfy the above condition. Alternatively, either the inner surface 71i or the outer surface 71o may satisfy the above condition. In other words, it is sufficient that at least one of the inner surface 71i and the outer surface 71o satisfies the above condition.

### Guidance and Discharge of Toner by Rotation of Rotary Assembly

Guidance of the toner and discharge of the toner through the discharge opening 71b when the rotary assembly 90A rotates will be described with reference to FIGS. 13, 14, 15A, 15B, 16, 17, and FIG. 30.

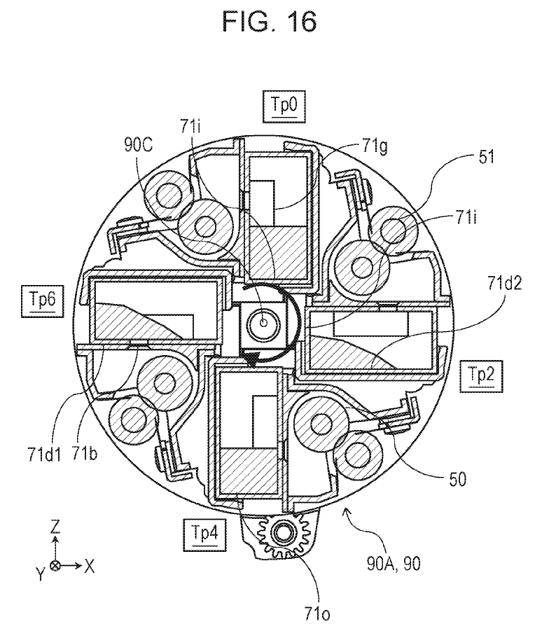

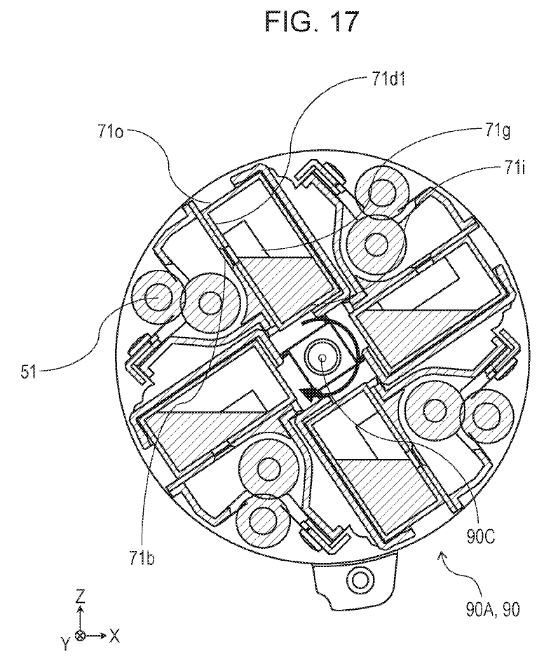

FIGS. 16, 17, and 30 are schematic views of the rotary assembly 90A rotating around the rotation axis 90C when viewed in the Y direction. FIGS. 16 and 17 show the toner cartridges 70 and the developing units 50 corresponding to the toner cartridges 70. FIG. 16 shows the toner cartridges 70 at respective positions Tp0, Tp2, Tp4, and Tp6, and the developing units 50 corresponding to the toner cartridges 70. In FIG. 17, the developing unit 50 at the upper left is at a developing position.

In the present embodiment, the rotary assembly 90A rotates clockwise in FIGS. 16 and 17. Therefore, in the rotation direction of the rotary assembly 90A (the rotation direction of the rotary body 90), the first receiving surface 71d1 is disposed on the upstream side of the second receiving surface 71d2. In FIG. 17, the toner cartridge 70 at the upper left corresponds to the developing unit 50 at the developing position and is located between position Tp6 and position Tp0.

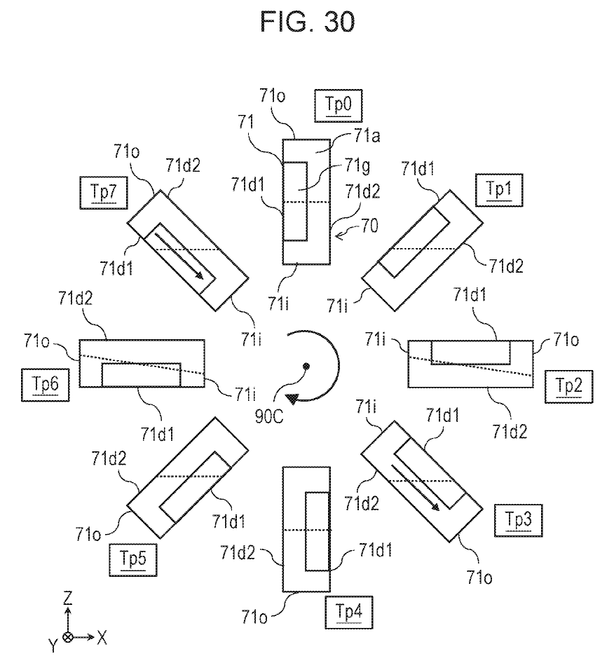

As described above, the guide portion 71g in the present embodiment guides, toward the discharge opening 71b in the longitudinal direction, the toner moving on the first receiving surface 71d1 from the outer end 71go toward the inner end 71gi in the transverse direction. As described above, when the toner cartridge 70 revolves from position Tp4 to position Tp0, the toner moves from the outer surface 71o toward the inner surface 71i in the transverse direction in a state in which the weight of the toner is borne by the first receiving surface 71d1 (see FIG. 30). In other words, in a state in which the weight of the toner is borne by the first receiving surface 71d1, the toner moves from the outer end 71go toward the inner end 71gi in the transverse direction. As a result, the toner is guided by the guide portion 71g toward the discharge opening 71b in the longitudinal direction.

In the present embodiment, the discharge opening 71b is provided in the first receiving surface 71d1, and, when the toner cartridge 70 revolves from position Tp4 to position Tp0, the discharge opening 71b is positioned above the receiving opening 53b. Therefore, when the toner cartridge 70 revolves from position Tp4 to position Tp0, the toner is discharged through the discharge opening 71b and supplied to the developing unit 50.

On the other hand, when the toner cartridge 70 revolves from position Tp0 to position Tp4, the toner moves from the inner surface 71i toward the outer surface 71o in the transverse direction in a state in which the weight of the toner is borne by the second receiving surface 71d2 (see FIG. 30). In other words, in a state in which the weight of the toner is borne by the second receiving surface 71d2, the toner moves from the inner end 71gi toward the outer end 71go in the transverse direction. At this time, the toner moves from the inner end 71gi toward the outer end 71go through the gap between the guide portion 71g and the second receiving surface 71d2.

If the toner moves on the first receiving surface 71d1 from the inner end 71gi toward the outer end 71go in the transverse direction, the toner is guided by the guide portion 71g so as to move away from the discharge opening 71b in the longitudinal direction. In the present embodiment, when the rotary body 90 (rotary assembly 90A) rotates and the toner moves from the inner end 71gi toward the outer end 71go, the toner moves through the gap between the guide portion 71g and the second receiving surface 71d2. The toner that moves through the gap between the guide portion 71g and the second receiving surface 71d2 is not guided by the guide portion 71g. Therefore, guidance of the toner by the guide portion 71g away from the discharge opening 71b in the longitudinal direction is suppressed.

In the present embodiment, the rotary body 90 (rotary assembly 90A) rotates, and the toner moves from the outer surface 71o toward the inner surface 71i and the toner also moves from the inner surface 71i toward the outer surface 71o in the transverse direction. When the toner moves from the outer surface 71o to the inner surface 71i, the toner is guided by the guide portion 71g toward the discharge opening 71b in the longitudinal direction. On the other hand, when the toner moves from the inner surface 71i to the outer surface 71o, guidance of the toner in the direction away from the discharge opening 71b in the longitudinal direction is suppressed.

Therefore, when the rotary body 90 (rotary assembly 90A) with the toner cartridge 70 attached rotates, the amount of toner moving in the direction to approach the discharge opening 71b in the longitudinal direction becomes greater than the amount of toner moving in the direction away from the discharge opening 71b in the longitudinal direction. The amount of toner moving away from the discharge opening 71b in the longitudinal direction may be zero. The rotary body 90 (rotary assembly 90A) may rotate multiple times.

In this way, in the present embodiment, toner is guided toward the discharge opening 71b in the longitudinal direction, and discharged through the discharge opening 71b. Therefore, toner stored in the toner storage chamber 71a can be efficiently discharged through the discharge opening 71b.

### Second Embodiment

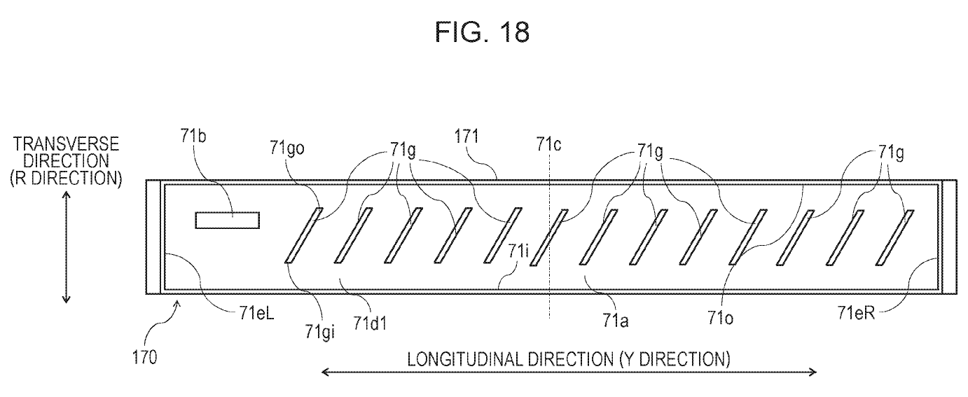

A toner cartridge 170 according to a second embodiment will be described with reference to FIG. 18. In the second embodiment, like reference signs denote components similar to those described in the first embodiment, and the detailed description is omitted in principle. FIG. 18 is a view that shows the internal structure of the toner cartridge 170 according to the second embodiment.

The toner cartridge 170 according to the second embodiment differs from the toner cartridge 70 according to the first embodiment in the arrangement of the guide portion 71g and the discharge opening 71b.

In other words, the toner frame 71 of the toner cartridge 70 in the first embodiment has the discharge openings 71bL and 71bR. On the other hand, a toner frame 171 of the toner cartridge 170 in the present embodiment has a single discharge opening 71b. The shape and arrangement of the discharge opening 71b of the present embodiment are the same as the shape and arrangement of the discharge opening 71bL of the first embodiment.

The toner frame 171 includes at least one guide portion 71g. The toner frame 171 of the present embodiment includes a plurality of guide portions 71g. In the present embodiment, the guide portion 71g has the same shape as the left-side guide 71gL of the first embodiment. In the longitudinal direction, the guide portions 71g are disposed between the center 71c of the toner frame 171 and the discharge opening 71b and between the center 71c and the right side surface 71eR. As in the first embodiment, there is a gap between the second receiving surface 71d2 and the guide portion 71g (see FIG. 14).

In the present embodiment as well, the rotary body 90 (rotary assembly 90A) rotates, and toner moves from the outer surface 71o toward the inner surface 71i and the toner also moves from the inner surface 71i toward the outer surface 71o in the transverse direction. When the toner moves from the outer surface 71o to the inner surface 71i, the toner is guided by the guide portion 71g toward the discharge opening 71b in the longitudinal direction. On the other hand, when the toner moves from the outer surface 71o to the inner surface 71i, guidance of toner in the direction away from the discharge opening 71b in the longitudinal direction is suppressed.

The shape and arrangement of the discharge opening 71b may be the same as the shape and arrangement of the discharge opening 71bR of the first embodiment. In this case, the guide portion 71g has the same shape as the right-side guide 71gR of the first embodiment. Then, the guide portions 71g can be disposed between the center 71c of the toner frame 171 and the discharge opening 71b and between the center 71c and the left side surface 71eL.

### Third Embodiment

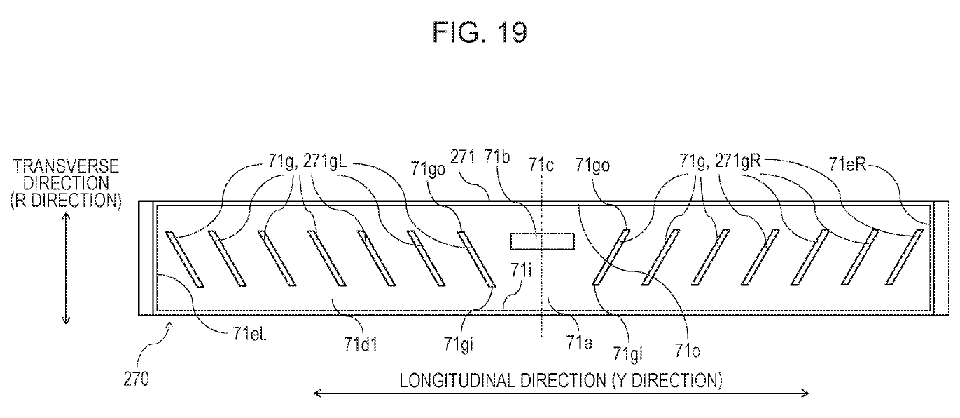

A toner cartridge 270 according to a third embodiment will be described with reference to FIG. 19. In the third embodiment, like reference signs denote components similar to those described in the first embodiment, and the detailed description is omitted in principle. FIG. 19 is a view that shows the internal structure of the toner cartridge 270 according to the third embodiment.

The toner cartridge 270 according to the third embodiment differs from the toner cartridge 70 according to the first embodiment in the arrangement of the guide portion 71g and the discharge opening 71b.

In other words, the toner frame 71 of the toner cartridge 70 in the first embodiment has the discharge openings 71bL and 71bR. On the other hand, a toner frame 271 of the toner cartridge 270 in the present embodiment has a single discharge opening 71b. The shape of the discharge opening 71b of the present embodiment is the same as the shape of the discharge opening 71b of the first embodiment. The discharge opening 71b of the present embodiment is disposed at a position where the discharge opening 71b overlaps the center 71c of the toner frame 271 in the longitudinal direction.

The toner frame 271 includes at least one guide portion 71g. The toner frame 271 of the present embodiment includes a plurality of guide portions 71g. More specifically, the toner frame 271 of the present embodiment includes at least one left-side guide 271gL and at least one right-side guide 271gR. In the present embodiment, the toner frame 271 includes a plurality of left-side guides 271gL and a plurality of right-side guides 271gR. The left-side guide 271gL and the right-side guide 271gR guide toner toward the discharge opening 71b in the Y direction.

In the present embodiment, the right-side guide 271gR has the same shape as the left-side guide 71gL of the first embodiment, and the left-side guide 271gL has the same shape as the right-side guide 71gR of the first embodiment. In the longitudinal direction, the left-side guides 271gL are disposed between the left side surface 71eL of the toner frame 271 and the discharge opening 71b, and the right-side guides 271gR are disposed between the right side surface 71eR and the discharge opening 71b. As in the first embodiment, there is a gap between the second receiving surface 71d2 and the guide portion 71g (see FIG. 14).

The left-side guides 271gL and the right-side guides 271gR have a symmetric shape in the longitudinal direction; however, the left-side guides 271gL and the right-side guides 271gR do not need to have a perfectly symmetric shape. The number of the left-side guides 271gL may be different from the number of the right-side guides 271gR.

In the present embodiment as well, the rotary body 90 (rotary assembly 90A) rotates, and toner moves from the outer surface 71o toward the inner surface 71i and the toner also moves from the inner surface 71i toward the outer surface 71o in the transverse direction. When the toner moves from the outer surface 71o to the inner surface 71i, the toner is guided by the guide portion 71g toward the discharge opening 71b in the longitudinal direction. On the other hand, when the toner moves from the outer surface 71o to the inner surface 71i, guidance of toner in the direction away from the discharge opening 71b in the longitudinal direction is suppressed.

### Modifications

In the above-described first to third embodiments, the rotary body 90 (rotary assembly 90A) rotates clockwise when viewed in the Y direction (see FIG. 15A). The guide portion 71g is disposed on the first receiving surface 71d1, and, when the toner moves from the outer surface 71o to the inner surface 71i, the guide portion 71g guides the toner toward the discharge opening 71b in the longitudinal direction. However, the present disclosure is not limited to the above configuration. Hereinafter, toner cartridges according to modifications will be described. Like reference signs denote components similar to those described in the first embodiment, and the detailed description is omitted in principle.

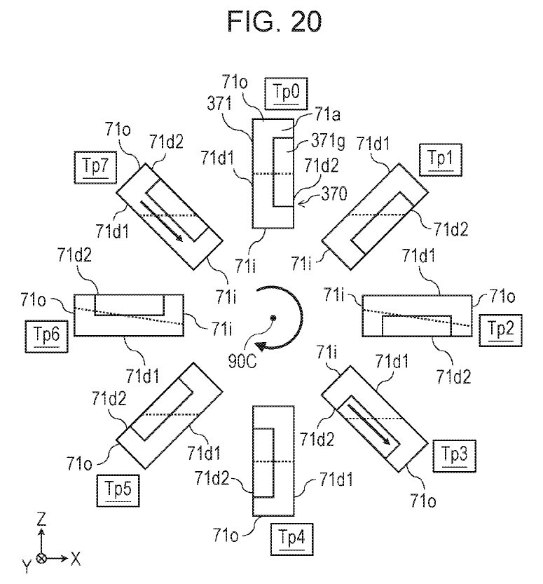

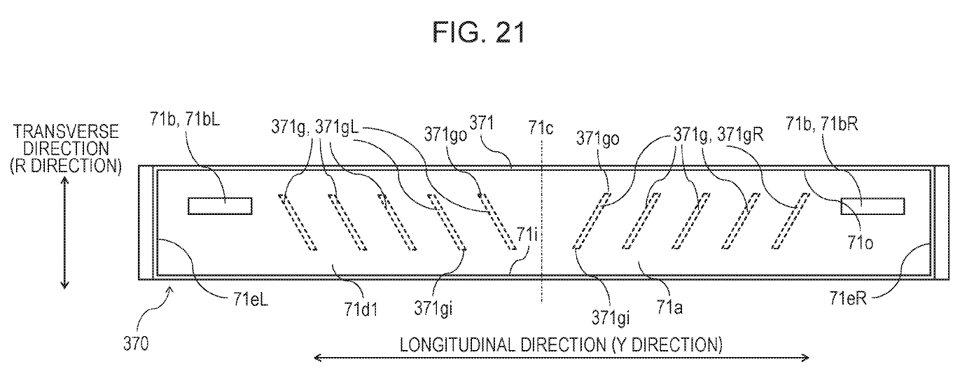

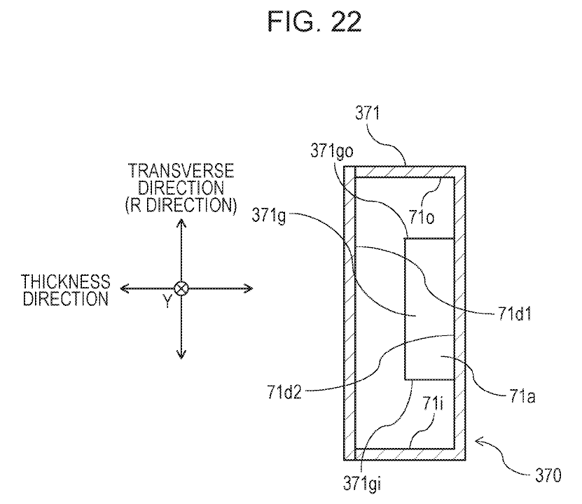

FIGS. 20, 21, and 22 are views that show a toner cartridge 370 according to a first modification. FIG. 20 is a schematic view that shows the toner cartridge 370 revolving around the rotation axis 90C when viewed in the Y direction. FIG. 21 is a view that shows the internal structure of the toner cartridge 370. FIG. 22 is a cross-sectional view that shows the internal structure of the toner cartridge 370 and, specifically, a cross-sectional view of the toner cartridge 370, taken in a direction orthogonal to the rotation axis 90C, when viewed in the Y direction.

As shown in FIG. 20, the rotary body 90 (rotary assembly 90A) according to the first modification rotates clockwise when viewed in the Y direction. Therefore, in the rotation direction of the rotary assembly 90A (the rotation direction of the rotary body 90), the first receiving surface 71d1 is disposed on the upstream side of the second receiving surface 71d2.

As shown in FIGS. 21 and 22, a toner frame 371 includes at least one guide portion 371g for guiding toner stored in the toner storage chamber 71a. The toner frame 371 of the first modification includes a plurality of guide portions 371g. Each of the guide portions 371g is configured to guide, toward the discharge opening 71b in the Y direction, the toner moving under the weight of the toner in a direction intersecting the Y direction.

In the first modification, the toner frame 371 includes at least one left-side guide 371gL and at least one right-side guide 371gR. The left-side guides 371gL guide the toner toward the discharge opening 71bL in the Y direction, and the right-side guides 371gR guide the toner toward the discharge opening 71bR in the Y direction.

In the longitudinal direction, the left-side guides 371gL are disposed between the center 71c of the toner frame 371 and the discharge opening 71bL, and the right-side guides 371gR are disposed between the center 71c of the toner frame 371 and the discharge opening 71bR. The left-side guides 371gL and the discharge opening 71bL and the right-side guides 371gR and the discharge opening 71bR have a symmetric shape in the longitudinal direction; however, the left-side guides 371gL and the discharge opening 71bL and the right-side guides 371gR and the discharge opening 71bR do not need to have a perfectly symmetric shape. The number of the left-side guides 371gL may be different from the number of the right-side guides 371gR.

The left-side guide 371gL and the right-side guide 371gR guide toner in different directions; however, the left-side guide 371gL and the right-side guide 371gR generally have substantially a common basic configuration and function. Therefore, in the following description, the left-side guide 371gL and the right-side guide 371gR are referred to as the guide portion 371g, the discharge opening 71bL and the discharge opening 71bR are referred to as the discharge opening 71b, and they will be collectively described.

As shown in FIG. 22, the guide portion 371g is closer to the second receiving surface 71d2 than to the first receiving surface 71d1. In the first modification, the guide portion 371g is disposed on the second receiving surface 71d2. In other words, the base of the guide portion 371g is connected to the second receiving surface 71d2. On the other hand, there is a gap between the guide portion 371g and the first receiving surface 71d1.

As shown in FIGS. 21 and 22, the guide portion 371g has an inner end 371gi and an outer end 371go. In the radial direction of the rotary body 90, the inner end 371gi is closer to the rotation axis 90c than the outer end 371go. In the longitudinal direction, the outer end 371go is closer to the discharge opening 71b than the inner end 371gi. When viewed in a direction perpendicular to the second receiving surface 71d2, the angle formed between a straight line passing through the outer end 371go and the inner end 371gi and the longitudinal direction is preferably larger than the angle of repose of the toner.

In the present embodiment, in the transverse direction, the distance between the inner end 371gi and the outer end 371go is less than the distance between the outer surface 71o and the inner surface 71i. In the transverse direction, the outer surface 71o faces the outer end 371go, and a gap is formed between the outer surface 71o and the outer end 371go. The inner surface 71i faces the inner end 371gi, and a gap is formed between the inner surface 71i and the inner end 371gi.

The guide portion 371g guides, toward the discharge opening 71b in the longitudinal direction, the toner moving from the inner end 371gi toward the outer end 371go in the transverse direction.

When the second receiving surface (first surface) 71d2 receives the weight of the toner and is inclined relative to the horizontal direction and the inclination angle of the second receiving surface 71d2 relative to the horizontal direction exceeds a predetermined angle, the toner moves on the second receiving surface 71d2 along the second receiving surface 71d2. At this time, the guide portion 371g guides, toward the discharge opening 71b in the longitudinal direction, the toner moving along the second receiving surface 71d2.

More specifically, assume that, in a state in which the second receiving surface 71d2 is positioned below the first receiving surface 71d1, the second receiving surface 71d2 is inclined relative to the horizontal direction such that the inner end of the second receiving surface 71d2 in the radial direction of the rotary body 90 is higher in level than the outer end of the second receiving surface 71d2. When the inclination angle of the second receiving surface 71d2 relative to the horizontal direction exceeds a predetermined angle, the toner moves along the second receiving surface 71d2 from the inner end of the second receiving surface 71d2 toward the outer end of the second receiving surface 71d2 in a direction intersecting the rotation axis 90c of the rotary body 90.

When the toner moving on the second receiving surface 71d2 contacts the surface of the guide portion 371g facing the discharge opening 71b in the longitudinal direction, the toner is guided by the guide portion 371g toward the discharge opening 71b in the longitudinal direction.

On the other hand, when the first receiving surface (second surface) 71d1 receives the weight of the toner and is inclined relative to the horizontal direction and the inclination angle of the first receiving surface 71d1 relative to the horizontal direction exceeds a predetermined angle, the toner moves on the first receiving surface 71d1 along the first receiving surface 71d1. At this time, the toner moves from one of the inner end 371gi and the outer end 371go toward the other of the inner end 371gi and the outer end 371go in the radial direction of the rotary body 90 through the gap between the guide portion 371g and the first receiving surface 71d1. The toner that moves through the gap between the guide portion 371g and the first receiving surface 71d1 can move without being guided by the guide portion 371g.

As described above, the guide portion 371g in the first modification guides, toward the discharge opening 71b in the longitudinal direction, the toner moving on the second receiving surface 71d2 from the inner end 371gi toward the outer end 371go in the transverse direction. As described above, when the toner cartridge 370 revolves from position Tp0 to position Tp4, the toner moves from the inner surface 71i toward the outer surface 71o in the transverse direction in a state in which the weight of the toner is borne by the second receiving surface 71d2 (see FIG. 20). In other words, in a state in which the weight of the toner is borne by the second receiving surface 71d2, the toner moves from the inner end 371gi toward the outer end 371go in the transverse direction. As a result, the toner is guided by the guide portion 371g toward the discharge opening 71b in the longitudinal direction.

In the first modification, the discharge opening 71b is provided in the first receiving surface 71d1, and, when the toner cartridge 370 revolves from position Tp4 to position Tp0, the discharge opening 71b is positioned above the receiving opening 53b. Therefore, when the toner cartridge 370 revolves from position Tp4 to position Tp0, the toner is discharged through the discharge opening 71b and supplied to the developing unit 50.

On the other hand, when the toner cartridge 370 revolves from position Tp4 to position Tp0, the toner moves from the outer surface 71o toward the inner surface 71i in the transverse direction in a state in which the weight of the toner is borne by the first receiving surface 71d1 (see FIG. 20). In other words, in a state in which the weight of the toner is borne by the first receiving surface 71d1, the toner moves from the outer end 371go toward the inner end 371gi in the transverse direction. At this time, the toner moves from the outer end 371go toward the inner end 371gi through the gap between the guide portion 371g and the first receiving surface 71d1.

If the toner moves on the second receiving surface 71d2 from the outer end 371go toward the inner end 371gi in the transverse direction, the toner is guided by the guide portion 371g so as to move away from the discharge opening 71b in the longitudinal direction. In the first modification, when the rotary body 90 (rotary assembly 90A) rotates and the toner moves from the outer end 371go toward the inner end 371gi, the toner moves through the gap between the guide portion 371g and the first receiving surface 71d1. The toner that moves through the gap between the guide portion 371g and the first receiving surface 71d1 is not guided by the guide portion 371g. Therefore, guidance of the toner by the guide portion 371g away from the discharge opening 71b in the longitudinal direction is suppressed.

In this way, in the first modification, the rotary body 90 (rotary assembly 90A) rotates, and the toner moves from the inner surface 71i toward the outer surface 71o and the toner also moves from the outer surface 71o toward the inner surface 71i in the transverse direction. When the toner moves from the inner surface 71i to the outer surface 71o, the toner is guided by the guide portion 371g toward the discharge opening 71b in the longitudinal direction. On the other hand, when the toner moves from the outer surface 71o to the inner surface 71i, guidance of the toner in the direction away from the discharge opening 71b in the longitudinal direction is suppressed.

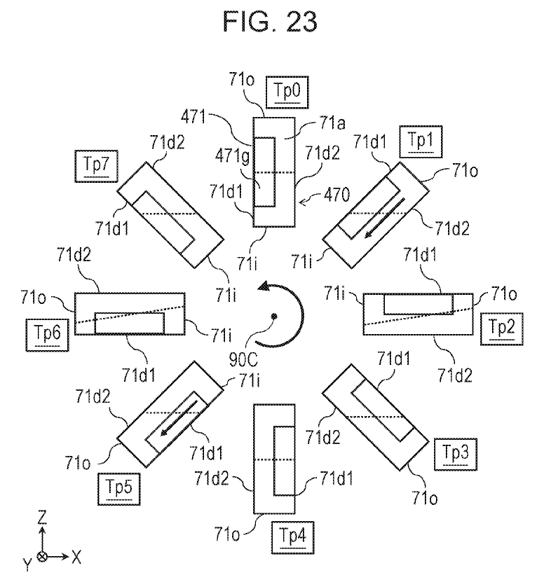

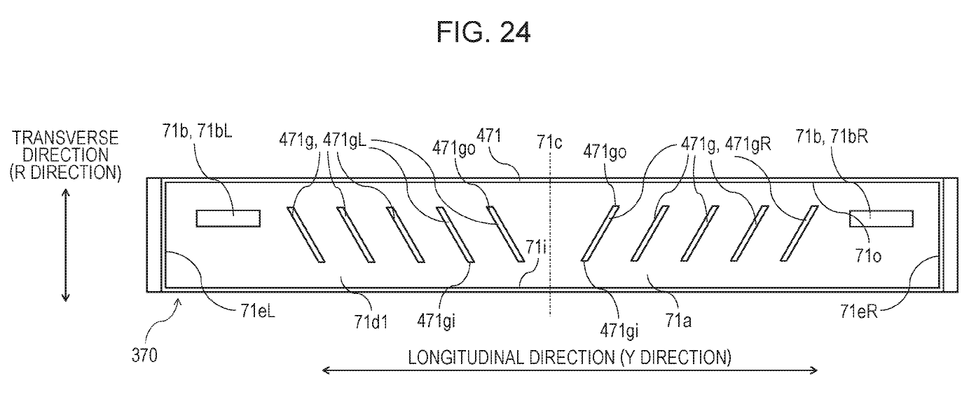

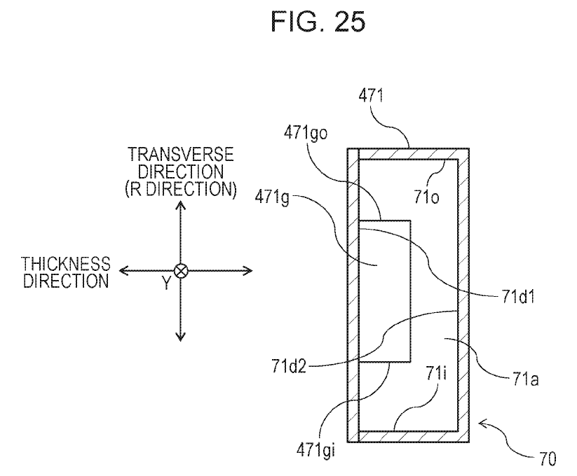

FIGS. 23, 24, and FIG. 25 are views that show a toner cartridge 470 according to a second modification. FIG. 23 is a schematic view that shows the toner cartridge 470 revolving around the rotation axis 90C when viewed in the Y direction. FIG. 24 is a view that shows the internal structure of the toner cartridge 470. FIG. 25 is a cross-sectional view that shows the internal structure of the toner cartridge 470 and, specifically, a cross-sectional view of the toner cartridge 470, taken in a direction orthogonal to the rotation axis 90C, when viewed in the Y direction.

As shown in FIG. 23, the rotary body 90 (rotary assembly 90A) according to the second modification rotates counterclockwise when viewed in the Y direction. Therefore, in the rotation direction of the rotary assembly 90A (the rotation direction of the rotary body 90), the second receiving surface 71d2 is disposed on the upstream side of the first receiving surface 71d1.

As shown in FIGS. 24 and 25, a toner frame 471 includes at least one guide portion 471g for guiding toner stored in the toner storage chamber 71a. The toner frame 471 of the second modification includes a plurality of guide portions 471g. Each of the guide portions 471g is configured to guide, toward the discharge opening 71b in the Y direction, the toner moving under the weight of the toner in a direction intersecting the Y direction.

In the second modification, the toner frame 471 includes at least one left-side guide 471gL and at least one right-side guide 471gR. The left-side guides 471gL guide the toner toward the discharge opening 71bL in the Y direction, and the right-side guides 471gR guide the toner toward the discharge opening 71bR in the Y direction.

In the longitudinal direction, the left-side guides 471gL are disposed between the center 71c of the toner frame 471 and the discharge opening 71bL, and the right-side guides 471gR are disposed between the center 71c of the toner frame 471 and the discharge opening 71bR. The left-side guides 471gL and the discharge opening 71bL and the right-side guides 471gR and the discharge opening 71bR have a symmetric shape in the longitudinal direction; however, the left-side guides 471gL and the discharge opening 71bL and the right-side guides 471gR and the discharge opening 71bR do not need to have a perfectly symmetric shape. The number of the left-side guides 471gL may be different from the number of the right-side guides 471gR.

The left-side guide 471gL and the right-side guide 471gR guide toner in different directions; however, the left-side guide 471gL and the right-side guide 471gR generally have substantially a common basic configuration and function. Therefore, in the following description, the left-side guide 471gL and the right-side guide 471gR are referred to as the guide portion 471g, the discharge opening 71bL and the discharge opening 71bR are referred to as the discharge opening 71b, and they will be collectively described.

As shown in FIG. 25, the guide portion 471g is closer to the first receiving surface 71d1 than to the second receiving surface 71d2. In the second modification, the guide portion 471g is disposed on the first receiving surface 71d1. In other words, the base of the guide portion 471g is connected to the first receiving surface 71d1. On the other hand, there is a gap formed between the guide portion 471g and the second receiving surface 71d2.

As shown in FIGS. 24 and 25, the guide portion 471g has an inner end 471gi and an outer end 471go. In the radial direction of the rotary body 90, the inner end 471gi is closer to the rotation axis 90c than the outer end 471go. In the longitudinal direction, the outer end 471go is closer to the discharge opening 71b than the inner end 471gi. When viewed in a direction perpendicular to the first receiving surface 71d1, the angle formed between a straight line passing through the outer end 471go and the inner end 471gi and the longitudinal direction is preferably larger than the angle of repose of the toner.

In the present embodiment, in the transverse direction, the distance between the inner end 471gi and the outer end 471go is less than the distance between the outer surface 71o and the inner surface 71i. In the transverse direction, the outer surface 71o faces the outer end 471go, and a gap is formed between the outer surface 71o and the outer end 471go. The inner surface 71i faces the inner end 471gi, and a gap is formed between the inner surface 71i and the inner end 471gi.

The guide portion 471g guides, toward the discharge opening 71b in the longitudinal direction, the toner moving from the inner end 471gi toward the outer end 471go in the transverse direction.

When the first receiving surface (first surface) 71d1 receives the weight of toner and is inclined relative to the horizontal direction and the inclination angle of the first receiving surface 71d1 relative to the horizontal direction exceeds a predetermined angle, the toner moves on the first receiving surface 71d1 along the first receiving surface 71d1. At this time, the guide portion 471g guides, toward the discharge opening 71b in the longitudinal direction, the toner moving along the first receiving surface 71d1.

More specifically, assume that, in a state in which the first receiving surface 71d1 is positioned below the second receiving surface 71d2, the first receiving surface 71d1 is inclined relative to the horizontal direction such that the inner end of the first receiving surface 71d1 in the radial direction of the rotary body 90 is higher in level than the outer end of the first receiving surface 71d1. When the inclination angle of the first receiving surface 71d1 relative to the horizontal direction exceeds a predetermined angle, the toner moves along the first receiving surface 71d1 from the inner end of the first receiving surface 71d1 toward the outer end of the first receiving surface 71d1 in a direction intersecting the rotation axis 90c of the rotary body 90.

When the toner moving on the first receiving surface 71d1 contacts the surface of the guide portion 471g facing the discharge opening 71b in the longitudinal direction, the toner is guided by the guide portion 471g toward the discharge opening 71b in the longitudinal direction.

On the other hand, when the second receiving surface (second surface) 71d2 receives the weight of the toner and is inclined relative to the horizontal direction and the inclination angle of the second receiving surface 71d2 relative to the horizontal direction exceeds a predetermined angle, the toner moves on the second receiving surface 71d2 along the second receiving surface 71d2. At this time, the toner moves from one of the inner end 471gi and the outer end 471go toward the other of the inner end 471gi and the outer end 471go in the radial direction of the rotary body 90 through the gap between the guide portion 471g and the second receiving surface 71d2. The toner that moves through the gap between the guide portion 471g and the second receiving surface 71d2 can move without being guided by the guide portion 471g.

As described above, the guide portion 471g in the second modification guides, toward the discharge opening 71b in the longitudinal direction, the toner moving on the first receiving surface 71d1 from the inner end 471gi toward the outer end 471go in the transverse direction. As described above, when the toner cartridge 470 revolves from position Tp0 to position Tp4, the toner moves from the inner surface 71i toward the outer surface 71o in the transverse direction in a state in which the weight of the toner is borne by the first receiving surface 71d1 (see FIG. 23). In other words, in a state in which the weight of the toner is borne by the first receiving surface 71d1, the toner moves from the inner end 471gi toward the outer end 471go in the transverse direction. As a result, the toner is guided by the guide portion 471g toward the discharge opening 71b in the longitudinal direction.

In the second modification, the discharge opening 71b is provided in the first receiving surface 71d1, and, when the toner cartridge 470 revolves from position Tp0 to position Tp4, the discharge opening 71b is positioned above the receiving opening 53b. Therefore, when the toner cartridge 470 revolves from position Tp0 to position Tp4, the toner is discharged through the discharge opening 71b and supplied to the developing unit 50.

On the other hand, when the toner cartridge 470 revolves from position Tp4 to position Tp0, the toner moves from the outer surface 71o toward the inner surface 71i in the transverse direction in a state in which the weight of the toner is borne by the second receiving surface 71d2 (see FIG. 23). In other words, in a state in which the weight of the toner is borne by the second receiving surface 71d2, the toner moves from the outer end 471go toward the inner end 471gi in the transverse direction. At this time, the toner moves from the outer end 471go toward the inner end 471gi through the gap between the guide portion 471g and the second receiving surface 71d2.

If the toner moves on the first receiving surface 71d1 from the outer end 471go toward the inner end 471gi in the transverse direction, the toner is guided by the guide portion 471g so as to move away from the discharge opening 71b in the longitudinal direction. In the second modification, when the rotary body 90 (rotary assembly 90A) rotates and the toner moves from the outer end 471go toward the inner end 471gi, the toner moves through the gap between the guide portion 471g and the second receiving surface 71d2. The toner that moves through the gap between the guide portion 471g and the second receiving surface 71d2 is not guided by the guide portion 471g. Therefore, guidance of the toner by the guide portion 471g away from the discharge opening 71b in the longitudinal direction is suppressed.

In this way, in the second modification, the rotary body 90 (rotary assembly 90A) rotates, and the toner moves from the inner surface 71i toward the outer surface 71o and the toner also moves from the outer surface 71o toward the inner surface 71i in the transverse direction. When the toner moves from the inner surface 71i to the outer surface 71o, the toner is guided by the guide portion 471g toward the discharge opening 71b in the longitudinal direction. On the other hand, when the toner moves from the outer surface 71o to the inner surface 71i, guidance of the toner in the direction away from the discharge opening 71b in the longitudinal direction is suppressed.

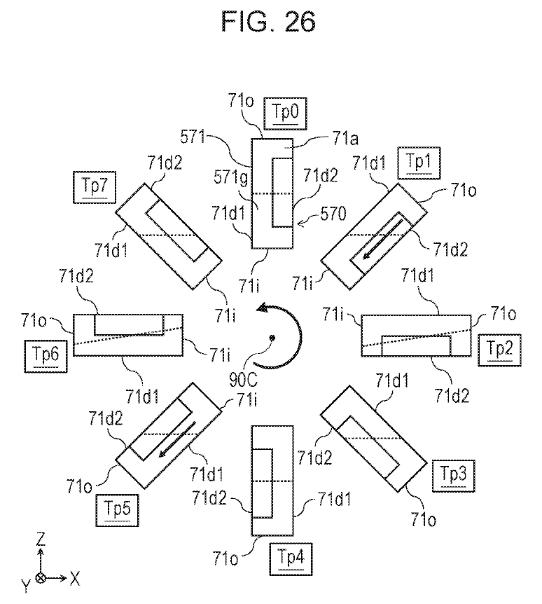

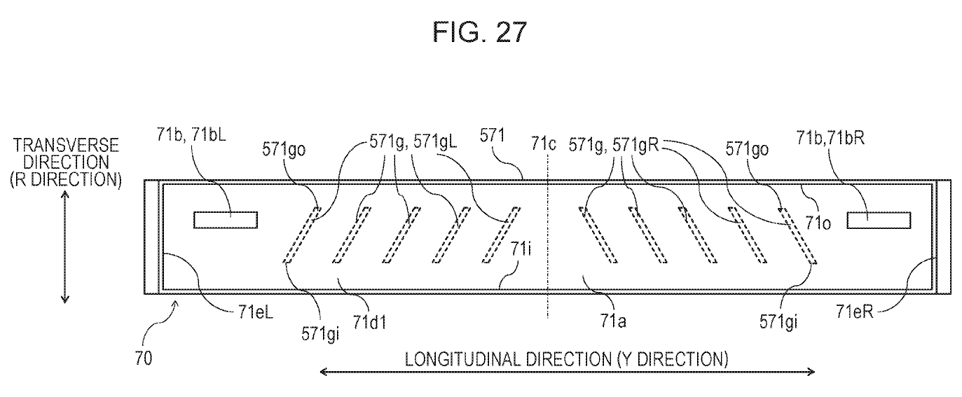

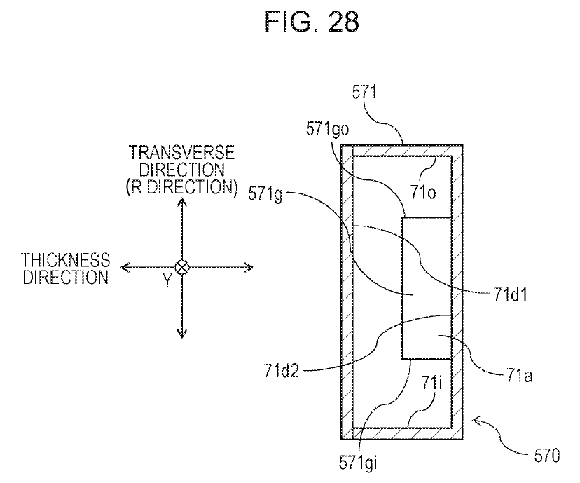

FIGS. 26, 27, and 28 are views that show a toner cartridge 570 according to a third modification. FIG. 26 is a schematic view that shows the toner cartridge 570 revolving around the rotation axis 90C when viewed in the Y direction. FIG. 27 is a view that shows the internal structure of the toner cartridge 570. FIG. 28 is a cross-sectional view that shows the internal structure of the toner cartridge 570 and, specifically, a cross-sectional view of the toner cartridge 570, taken in a direction orthogonal to the rotation axis 90C, when viewed in the Y direction.

As shown in FIG. 26, the rotary body 90 (rotary assembly 90A) according to the third modification rotates counterclockwise when viewed in the Y direction. Therefore, in the rotation direction of the rotary assembly 90A (the rotation direction of the rotary body 90), the second receiving surface 71d2 is disposed on the upstream side of the first receiving surface 71d1.

As shown in FIGS. 27 and 28, a toner frame 571 includes at least one guide portion 571g for guiding toner stored in the toner storage chamber 71a. The toner frame 571 of the third modification includes a plurality of guide portions 571g. Each of the guide portions 571g is configured to guide, toward the discharge opening 71b in the Y direction, the toner moving under the weight of the toner in a direction intersecting the Y direction.

In the third modification, the toner frame 571 includes at least one left-side guide 571gL and at least one right-side guide 571gR. The left-side guides 571gL guide the toner toward the discharge opening 71bL in the Y direction, and the right-side guides 571gR guide the toner toward the discharge opening 71bR in the Y direction.

In the longitudinal direction, the left-side guides 571gL are disposed between the center 71c of the toner frame 571 and the discharge opening 71bL, and the right-side guides 571gR are disposed between the center 71c of the toner frame 571 and the discharge opening 71bR. The left-side guides 571gL and the discharge opening 71bL and the right-side guides 571gR and the discharge opening 71bR have a symmetric shape in the longitudinal direction; however, the left-side guides 571gL and the discharge opening 71bL and the right-side guides 571gR and the discharge opening 71bR do not need to have a perfectly symmetric shape. The number of the left-side guides 571gL may be different from the number of the right-side guides 571gR.

The left-side guide571gL and the right-side guide 571gR guide toner in different directions; however, the left-side guide 571gL and the right-side guide 571gR generally have substantially a common basic configuration and function. Therefore, in the following description, the left-side guide 571gL and the right-side guide 571gR are referred to as the guide portion 571g, the discharge opening 71bL and the discharge opening 71bR are referred to as the discharge opening 71b, and they will be collectively described.

As shown in FIG. 28, the guide portion 571g is closer to the second receiving surface 71d2 than to the first receiving surface 71d1. In the third modification, the guide portion 571g is disposed on the second receiving surface 71d2. In other words, the base of the guide portion 571g is connected to the second receiving surface 71d2. On the other hand, there is a gap between the guide portion 571g and the first receiving surface 71d1.

As shown in FIGS. 27 and 28, the guide portion 571g has an inner end 571gi and an outer end 571go. In the radial direction of the rotary body 90, the inner end 571gi is closer to the rotation axis 90c than the outer end 571go. In the longitudinal direction, the inner end 571gi is closer to the discharge opening 71b than the outer end 571go. When viewed in a direction perpendicular to the first receiving surface 71d1, the angle formed between a straight line passing through the inner end 571gi and the outer end 571go and the longitudinal direction is preferably larger than the angle of repose of the toner.

In the present embodiment, in the transverse direction, the distance between the inner end 571gi and the outer end 571go is less than the distance between the outer surface 71o and the inner surface 71i. In the transverse direction, the outer surface 71o faces the outer end 571go, and a gap is formed between the outer surface 71o and the outer end 571go. The inner surface 71i faces the inner end 571gi, and a gap is formed between the inner surface 71i and the inner end 571gi.

The guide portion 571g guides, toward the discharge opening 71b in the longitudinal direction, the toner moving from the outer end 571go toward the inner end 571gi in the transverse direction.

When the second receiving surface (first surface) 71d2 receives the weight of the toner and is inclined relative to the horizontal direction and the inclination angle of the second receiving surface 71d2 relative to the horizontal direction exceeds a predetermined angle, the toner moves on the second receiving surface 71d2 along the second receiving surface 71d2. At this time, the guide portion 571g guides, toward the discharge opening 71b in the longitudinal direction, the toner moving along the second receiving surface 71d2.

More specifically, assume that, in a state in which the second receiving surface 71d2 is positioned below the first receiving surface 71d1, the second receiving surface 71d2 is inclined relative to the horizontal direction such that the outer end of the second receiving surface 71d2 in the radial direction of the rotary body 90 is higher in level than the inner end of the second receiving surface 71d2. When the inclination angle of the second receiving surface 71d2 relative to the horizontal direction exceeds a predetermined angle, the toner moves along the second receiving surface 71d2 from the outer end of the second receiving surface 71d2 toward the inner end of the second receiving surface 71d2 in a direction intersecting the rotation axis 90c of the rotary body 90.

When the toner moving on the second receiving surface 71d2 contacts the surface of the guide portion 571g facing the discharge opening 71b in the longitudinal direction, the toner is guided by the guide portion 571g toward the discharge opening 71b in the longitudinal direction.

On the other hand, when the first receiving surface (second surface) 71d1 receives the weight of the toner and is inclined relative to the horizontal direction and the inclination angle of the first receiving surface 71d1 relative to the horizontal direction exceeds a predetermined angle, the toner moves on the first receiving surface 71d1 along the first receiving surface 71d1. At this time, the toner passes through the gap between the guide portion 571g and the first receiving surface 71d1, and the toner moves from one of the inner end 571gi and the outer end 571go toward the other of the inner end 571gi and the outer end 571go in the radial direction of the rotary body 90. The toner that moves through the gap between the guide portion 571g and the first receiving surface 71d1 can move without being guided by the guide portion 571g.

As described above, the guide portion 571g in the third modification guides, toward the discharge opening 71b in the longitudinal direction, the toner moving on the second receiving surface 71d2 from the outer end 571gi toward the inner end 571go in the transverse direction. As described above, when the toner cartridge 570 revolves from position Tp4 to position Tp0, the toner moves from the outer surface 71i toward the inner surface 71o in the transverse direction in a state in which the weight of the toner is borne by the second receiving surface 71d2 (see FIG. 26). In other words, in a state in which the weight of the toner is borne by the second receiving surface 71d2, the toner moves from the outer end 571gi toward the inner end 571go in the transverse direction. As a result, the toner is guided by the guide portion 571g toward the discharge opening 71b in the longitudinal direction.

In the third modification, the discharge opening 71b is provided in the first receiving surface 71d1, and, when the toner cartridge 570 revolves from position Tp0 to position Tp4, the discharge opening 71b is positioned above the receiving opening 53b. Therefore, when the toner cartridge 570 revolves from position Tp0 to position Tp4, the toner is discharged through the discharge opening 71b and supplied to the developing unit 50.

On the other hand, when the toner cartridge 570 revolves from position Tp0 to position Tp4, the toner moves from the inner surface 71o toward the outer surface 71i in the transverse direction in a state in which the weight of the toner is borne by the first receiving surface 71d1 (see FIG. 26). In other words, in a state in which the weight of the toner is borne by the first receiving surface 71d1, the toner moves from the inner end 571go toward the outer end 571gi in the transverse direction. At this time, the toner moves from the inner end 571go toward the outer end 571gi through the gap between the guide portion 571g and the second receiving surface 71d2.

If the toner moves on the second receiving surface 71d2 from the inner end 571go toward the outer end 571gi in the transverse direction, the toner is guided by the guide portion 571g so as to move away from the discharge opening 71b in the longitudinal direction. In the third modification, when the rotary body 90 (rotary assembly 90A) rotates and the toner moves from the inner end 571go toward the outer end 571gi, the toner moves through the gap between the guide portion 571g and the first receiving surface 71d1. The toner that moves through the gap between the guide portion 571g and the first receiving surface 71d1 is not guided by the guide portion 571g. Therefore, guidance of the toner by the guide portion 571g away from the discharge opening 71b in the longitudinal direction is suppressed.

In this way, in the third modification, the rotary body 90 (rotary assembly 90A) rotates, and the toner moves from the outer surface 71i toward the inner surface 71o and the toner also moves from the inner surface 71o toward the outer surface 71i in the transverse direction. When the toner moves from the outer surface 71i to the inner surface 71o, the toner is guided by the guide portion 571g toward the discharge opening 71b in the longitudinal direction. On the other hand, when the toner moves from the inner surface 71o to the outer surface 71i, guidance of the toner in the direction away from the discharge opening 71b in the longitudinal direction is suppressed.

In the first to third modifications as well, when the rotary body 90 (rotary assembly 90A) rotates, the amount of toner moving in the direction to approach the discharge opening 71b in the longitudinal direction becomes greater than the amount of toner moving in the direction away from the discharge opening 71b in the longitudinal direction. The amount of toner moving away from the discharge opening 71b in the longitudinal direction may be zero. The rotary body 90 (rotary assembly 90A) may rotate multiple times.

In this way, in the first to third modifications, the toner is guided toward the discharge opening 71b in the longitudinal direction, and discharged through the discharge opening 71b. Therefore, toner stored in the toner storage chamber 71a can be efficiently discharged through the discharge opening 71b.

In the first to third modifications as well, each of the guide portion 371g, 471g, and 571g may be connected to at least one of the outer surface 71o and the inner surface 71i. Even when the discharge opening 71b is disposed at a position described in each of the second embodiment and the third embodiment, the arrangement and shape of each of the guide portions 371g, 471g, and 571g in the first to third modifications may be appropriately changed such that the toner is guided to the discharge opening 71b.

As described above in the first to third embodiments and the first to third modifications, in the direction of the rotation axis 90C, one of the inner end and the outer end of the guide portion is closer to the discharge opening 71b than the other of the inner end and the outer end. The guide portion is configured to guide, toward the discharge opening 71b in the direction of the rotation axis 90C, the toner moving from the other of the inner end and the outer end toward the one of the inner end and the outer end in the radial direction.

The guide portion (71g, 371g, 471g, 571g) is configured to guide, toward the discharge opening 71b in the longitudinal direction (the direction of the rotation axis 90C), the toner moved by a change in the posture of the toner cartridge. In the present embodiment, the posture of the toner cartridge changes when the rotary assembly 90A (the rotary body 90 to which the toner cartridge is attached) rotates. In other words, the guide portion (70g to 571g) guides, toward the discharge opening 71b in the longitudinal direction (the direction of the rotation axis 90C), the toner moved by rotation of the rotary assembly 90A (more specifically, the toner moved in the radial direction of the rotary assembly 90).

As described above, the toner cartridge includes a plurality of guide portions (70g, 371g, 471g, 571g). At least a part of the toner guided by one guide portion is guided by a guide portion adjacent to the one guide portion when the rotary assembly 90A further rotates. By repeatedly rotating the rotary assembly 90A, transfer of the toner between a plurality of guide portions is repeated. As a result, the toner is guided toward the discharge opening 71b in the longitudinal direction.

In the above-described embodiments and modifications, the configuration that the rotary body 90 includes four developing units 50y to 50k and color images can be formed by using four colors of toner has been described. Alternatively, the rotary body 90 may include three or fewer developing units, or may include five or more developing units. For example, the rotary body 90 may include only one developing unit 50k, and may be configured to mount only one toner cartridge 70k on the rotary body 90. In this case, the rotary body 90 can rotate clockwise around the rotation axis 90C in FIG. 1 and can alternately take the black replacement posture and the black development posture.

In the above-described embodiments and modifications, the configuration that the rotary body 90 includes four developing units 50y to 50k and color images can be formed by using four colors of toner has been described. Alternatively, the rotary body 90 may include a plurality of developing units capable of performing image formation using toner of the same color. For example, the rotary body 90 may be configured to include four black developing units 50k and mount four toner cartridges 70k on the rotary body 90.

In the above-described embodiments and modifications, the toner cartridge is mounted on the rotary body 90 such that the longitudinal direction aligns with the direction of the rotation axis 90C of the rotary body 90. As shown in FIG. 1, the toner cartridge is mounted on the rotary body 90 such that the transverse direction aligns with the radial direction of the rotary body 90, and the thickness direction aligns with the rotation direction of the rotary body 90. In other words, the angle (acute angle) formed between the radial direction of the rotary body 90 and the transverse direction is smaller than the angle (acute angle) formed between the rotation direction of the rotary body 90 and the transverse direction. The angle (acute angle) formed between the rotation direction of the rotary body 90 and the thickness direction is smaller than the angle (acute angle) formed between the radial direction of the rotary body 90 and the thickness direction.

In a state in which the toner cartridge is mounted on the rotary body 90, the length of the toner cartridge in the rotation direction of the rotary body 90 may be regarded as being less than the length of the toner cartridge in the radial direction of the rotary body 90.

In the present embodiment, the length of the toner cartridge in the rotation direction of the rotary body 90 is defined as follows. As shown in FIG. 15A, when viewed in the direction of the rotation axis 90C, among imaginary circles centered on the rotation axis 90C of the rotary body 90 and overlapping the toner cartridge, a circle having the longest arc length overlapping the toner cartridge is referred to as a length defining circle LDC. The length of the toner cartridge in the rotation direction of the rotary body 90 refers to the arc length of a portion LPC of the length defining circle LDC, overlapping the toner cartridge.

In the present embodiment, the length of the toner cartridge in the radial direction of the rotary body 90 is defined as follows. As shown in FIG. 15A, when viewed in the direction of the rotation axis 90C, among straight lines passing through the rotation axis 90C of the rotary body 90 and overlapping the toner cartridge, a straight line having the longest straight line length overlapping the toner cartridge is referred to as a length defining line LDL. The length of the toner cartridge in the radial direction of the rotary body 90 refers to the length of a portion LPL of the length defining line LDL, overlapping the toner cartridge.

As a result of the toner cartridge being disposed as described above relative to the rotary body 90, the length of the arrangement space for the toner cartridge in the rotation direction of the rotary body 90 reduces, so the toner cartridge can be efficiently disposed while the rotary body 90 is downsized. More specifically, the developing units 50y to 50k and the toner cartridges 70y to 70k corresponding to the developing units 50y to 50k can be disposed in a small space in the rotation direction of the rotary body 90.

Furthermore, as described above, in the embodiments and the modifications, the surface having the discharge opening 71b extends so as to intersect (preferably, be orthogonal to) the thickness direction. As a result, the toner is easily supplied from the toner cartridge to the developing unit 50. The surface to which the guide portion (71g, 171g, 271g, 371g, 471g, 571g) is connected extends so as to intersect (preferably, be orthogonal to) the thickness direction. When the rotary assembly 90A rotates, the amount of movement of the toner moving on the surface that extends so as to intersect the thickness direction is greater than the amount of movement of the toner moving on the surface that extends so as to intersect the transverse direction. Therefore, when the guide portion is connected to the surface that extends so as to intersect the thickness direction, the toner can be moved significantly along the guide portion.

In the embodiments and the modifications, the guide portion (71g, 171g, 271g, 371g, 471g, 571g) is connected to the surface on an opposite side of the toner frame 71 from an outer appearance surface. In other words, the guide portion 71g is connected to the outer wall of the toner frame 71. When the rotary assembly 90A rotates, toner stored in the toner storage chamber 71a moves along the surface on the opposite side from the outer appearance surface. Since the guide portion is connected to the surface on the opposite side of the toner frame 71 from the outer appearance surface, the toner can be moved significantly along the guide portion.

In the embodiments and the modifications, the toner is guided by the guide portion (71g, 171g, 271g, 371g, 471g, 571g) adjacent to the discharge opening 71b, and is then received by at least one of the outer surface 71o and the inner surface 71i before reaching the discharge opening 71b. As a result, in the longitudinal direction, the toner tends to spread such that the position of the toner overlaps the position of the discharge opening 71b.

According to the present disclosure, it is possible to provide a new image forming apparatus that has advanced the existing technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming apparatus comprising:
a developing unit including a developing roller;
a rotary supporting the developing unit, the rotary being rotatable around a rotation axis extending in an axial direction; and
a toner cartridge detachably mounted on the rotary, the toner cartridge including a toner frame, the toner frame including
(i) a storage chamber storing toner, (ii) a guide portion configured to guide the toner, and (iii) a discharge opening through which the toner supplied from the storage chamber to the developing unit passes, wherein
the guide portion is configured to guide, toward the discharge opening in the axial direction, the toner moving under a weight of the toner in a direction intersecting the axial direction,
the guide portion includes an inner end and an outer end, and, when viewed in the axial direction of the rotary, the inner end is closer to the rotation axis than the outer end in a radial direction of the rotary,
a length of the toner frame in a longitudinal direction of the toner frame is greater than a length of the toner frame in a transverse direction of the toner frame, and the length of the toner frame in the transverse direction is greater than a length of the toner frame in a thickness direction of the toner frame, and
the toner frame has a surface having the discharge opening and a surface to which the guide portion is connected, the surface having the discharge opening extends so as to intersect the thickness direction, and the surface to which the guide portion is connected extends so as to intersect the thickness direction.

2. The image forming apparatus according to claim 1, wherein
in the axial direction, one of the inner end and the outer end is closer to the discharge opening than the other of the inner end and the outer end, and
the guide portion is configured to guide, toward the discharge opening in the axial direction, the toner moving in the radial direction from the other of the inner end and the outer end toward the one of the inner end and the outer end.

3. The image forming apparatus according to claim 2, wherein
the toner frame has a first surface facing the storage chamber and a second surface facing the storage chamber and the first surface, and
in a state in which the first surface receives the weight of the toner and is inclined relative to a horizontal direction, the guide portion is configured to guide, toward the discharge opening in the axial direction, the toner moving along the first surface.

4. The image forming apparatus according to claim 3, wherein a gap is formed between the second surface and the guide portion.

5. The image forming apparatus according to claim 4, wherein, in a state in which the second surface receives the weight of the toner and is inclined relative to the horizontal direction, the toner moves through the gap in the radial direction from the one of the inner end and the outer end toward the other of the inner end and the outer end.

6. The image forming apparatus according to claim 4, wherein the toner frame has an inner surface facing the inner end and an outer surface facing the outer end, the inner surface is closer to the rotation axis than the outer surface in the radial direction, a gap is formed between the inner surface and the inner end, and a gap is formed between the outer surface and the outer end.

7. The image forming apparatus according to claim 3, wherein the toner frame has an inner surface facing the inner end and an outer surface facing the outer end, the inner surface is closer to the rotation axis than the outer surface in the radial direction, a gap is formed between the inner surface and the inner end, and a gap is formed between the outer surface and the outer end.

8. The image forming apparatus according to claim 3, wherein the discharge opening faces the second surface.

9. The image forming apparatus according to claim 3, wherein the discharge opening faces the first surface.

10. An image forming apparatus comprising:
a developing unit including a developing roller;
a rotary supporting the developing unit, the rotary being rotatable around a rotation axis extending in an axial direction; and
a toner cartridge detachably mounted on the rotary, the toner cartridge including a toner frame, the toner frame including
(i) a storage chamber storing toner, (ii) a guide portion configured to guide the toner, and (iii) a discharge opening through which the toner supplied from the storage chamber to the developing unit passes, wherein
the guide portion is configured to guide, toward the discharge opening in the axial direction, the toner moved by rotation of the rotary,
the guide portion includes an inner end and an outer end, and, when viewed in the axial direction of the rotary, the inner end is closer to the rotation axis than the outer end in a radial direction of the rotary,
a length of the toner frame in a longitudinal direction of the toner frame is greater than a length of the toner frame in a transverse direction of the toner frame, and the length of the toner frame in the transverse direction is greater than a length of the toner frame in a thickness direction of the toner frame, and
the toner frame has a surface having the discharge opening and a surface to which the guide portion is connected, the surface having the discharge opening extends so as to intersect the thickness direction, and the surface to which the guide portion is connected extends so as to intersect the thickness direction.

11. The image forming apparatus according to claim 10, wherein
in the axial direction, one of the inner end and the outer end is closer to the discharge opening than the other of the inner end and the outer end, and
the guide portion is configured to guide, toward the discharge opening in the axial direction, the toner moving in the radial direction from the other of the inner end and the outer end toward the one of the inner end and the outer end.

12. The image forming apparatus according to claim 11, wherein
the toner frame has a first surface facing the storage chamber and a second surface facing the storage chamber and the first surface, and
in a state in which the first surface receives a weight of the toner and is inclined relative to a horizontal direction, the guide portion is configured to guide, toward the discharge opening in the axial direction, the toner moving along the first surface.

13. The image forming apparatus according to claim 12, wherein a gap is formed between the second surface and the guide portion.

14. The image forming apparatus according to claim 13, wherein, in a state in which the second surface receives the weight of the toner and is inclined relative to the horizontal direction, the toner moves through the gap in the radial direction from the one of the inner end and the outer end toward the other of the inner end and the outer end.

15. The image forming apparatus according to claim 13, wherein the toner frame has an inner surface facing the inner end and an outer surface facing the outer end, the inner surface is closer to the rotation axis than the outer surface in the radial direction, a gap is formed between the inner surface and the inner end, and a gap is formed between the outer surface and the outer end.

16. The image forming apparatus according to claim 12, wherein the toner frame has an inner surface facing the inner end and an outer surface facing the outer end, the inner surface is closer to the rotation axis than the outer surface in the radial direction, a gap is formed between the inner surface and the inner end, and a gap is formed between the outer surface and the outer end.

17. The image forming apparatus according to claim 12, wherein the discharge opening faces the second surface.

18. The image forming apparatus according to claim 12, wherein the discharge opening faces the first surface.

19. The image forming apparatus according to claim 1, wherein the toner frame includes a plurality of toner guides, and each of the plurality of toner guides is the guide portion.

20. The image forming apparatus according to claim 1, wherein
the toner frame includes a first opening and a second opening, and each of the first opening and the second opening is
the discharge opening, and
the toner frame includes a plurality of toner guides, and the plurality of toner guides include a guide portion configured to guide the toner toward the first opening in the axial direction and a guide portion configured to guide the toner toward the second opening in the axial direction.

21. The image forming apparatus according to claim 1, wherein the toner cartridge is mounted on the rotary such that a length of the toner cartridge in the radial direction is greater than a length of the toner cartridge in a rotation direction of the rotary.
